(19) United States
(12) Patent Application Publication
(10) Pub. No.: US 2004/0255199 A1
(43) Pub. Date: Dec. 16, 2004

(54) Debug system, microprocessor, and debugger

(76) Inventor: Takio Yamashita, Souraku-gun (JP)

Correspondence Address: MCDERMOTT, WILL & EMERY, 600 13th Street, N.W., Washington, DC, 20005-3096, US

(21) Appl. No.: 10/802,048

(22) Filed: Mar. 17, 2004

(30) Foreign Application Priority Data
Mar. 19, 2003 (JP) 2003-076145

(51) Int. Cl. H02H 3/05

(52) U.S. Cl. 714/37

(57) ABSTRACT

The present invention provides a debug system in which both a debug operation for a microprocessor and security of information stored in the debug system are achieved.

According to the microprocessor of the present invention, when a user inputs a key code on a host PC, the microprocessor stored the key code therein and also encrypts an instruction and data using the key code so as to send it to the host PC. Even when a vicious user connects a microprocessor to a debug unit and obtains an encrypted instruction and encrypted data, s/he can not decrypt the encrypted instruction and the encrypted data unless s/he knows the key code.

This application is based on an application No. 2003-076145 filed in Japan, the content of which is hereby incorporated by reference.

### BACKGROUND OF THE INVENTION

(1) Field of the Invention

The present invention relates to a microprocessor and a technique for debugging the same.

(2) Description of the Related Art

In recent years, an IC card equipped with an IC chip have been used in an electronic money system. An IC chip is a microcomputer system including a microprocessor, a Read Only Memory (ROM), a Random Access Memory (RAM) and the like. Here, the ROM stores a control computer program, and the microprocessor executes the control computer program to control electronic money transaction by means of an IC card.

A microprocessor in an IC card includes a debug interface, which enables the microprocessor to be debugged even after the microprocessor is designed or shipped. Here, debugging denotes the following operation. A debug unit is connected to a host personal computer (hereinafter referred to as a host PC). A debugger operating on the host PC extracts an instruction or data stored in a memory in the microprocessor and displays it on the host PC. In addition, the debugger finds and corrects a bug in a program, by writing an instruction or data that is input on the host PC to the memory in the microprocessor.

If such a microprocessor equipped with a debug interface is mounted on an IC card that is used in an electronic money system, there is a risk that a hostile analyzer illegally analyzes and falsifies an instruction and data stored in the microprocessor. Accordingly, a microprocessor that is used in such a system requires high-level security so that analysis and falsification of an instruction and data stored in the microprocessor are prevented.

Document 1 (Japanese unexamined patent application publication No. 2000-357085) discloses an information protection system composed of a ROM storing therein a program, an input/output device for writing the program to the ROM, a semiconductor processor for reading the program from the ROM. Here, the semiconductor processor writes an encrypted program into the ROM, and reads and decrypts an encrypted program from the ROM.

Document 2 (Japanese unexamined patent application publication No. 2000-347942) discloses an information processing apparatus which protects information stored in a ROM against illegal access by means of a debug tool that is disposed outside of the apparatus.

The information processing apparatus includes a memory and an on-chip debug circuit.

The memory stores information that should be protected against illegal access by means of an emulator disposed outside of the information processing apparatus and a security deactivating program that is set by an individual user. The on-chip debug circuit is connected to the emulator, so as to control input and output of signals for a debug operation between the emulator and the information processing apparatus and to support debugging of the operation of the information processing apparatus.

On reception of a power-on-reset signal to reset the apparatus at the time of power-on, the information processing apparatus deactivates the function of the on-chip debug circuit, so as to activate security. Thus, the emulator is inhibited from reading the information stored in the memory.

On reception of setting of a security indication bit and an enable code to inhibit resetting of the security indication bit, the information processing apparatus activates the function of the on-chip debug circuit, so as to deactivates the security. Thus, the emulator is allowed to read the information stored in the memory.

As described above, an encryption circuit is provided for a microprocessor to protect internal information, and the internal information is encrypted to be output to an external device in the related art. In detail, a microprocessor holds a key code that is set when the microprocessor is designed, and uses the key code to encrypt instructions and data. A debugger operating on a host PC includes a decryption circuit, and receives encrypted instructions and data from the microprocessor. The debugger then receives an input of the key code and decrypts the encrypted instructions and data. This means that only a person who knows a key code stored in a microprocessor can obtain instructions and data that has been properly decrypted so as to perform a debug operation.

However, since a key code is written into such a microprocessor when the microprocessor is designed, the key code is known to people engaged in system development such as designers of the microprocessor and a debugger. Here, an IC card used in an electronic money system is taken as an example. A manufacturer of a microprocessor in an IC card, a manufacturer of the IC card, and a supplier of the IC card are different from one another. Accordingly, manufacturers of a microprocessor and an IC card can be users of the electronic money system. This poses a problem that those manufacturers can connect a debug unit to a microprocessor so as to analyze and falsify information in the microprocessor.

### SUMMARY OF THE INVENTION

In view of the above problem, the object of the present invention is to provide a microprocessor, a debugger, and a debug system in which a debug operation for the operation of the microprocessor and security of information stored in the microprocessor are both achieved.

The above object can be achieved by a debug system comprising a microprocessor operable to store secret program information, and a host computer that is connected to the microprocessor so as to debug the program information in the microprocessor.

The microprocessor includes a nonvolatile memory which (i) has an area for storing key information that is used to securely handle program information and (ii) is writable only once. If no key information is stored in the nonvolatile memory, the microprocessor receives key information from the host computer and write the key information into the nonvolatile memory. The microprocessor securely performs transmission of program information with the host computer using the key information that has been written into the nonvolatile memory.

Here, the key information that has been written into the nonvolatile memory is not readable outside of the microprocessor.

The host computer receives key information from a user, stores the key information received from the user, and sends the key information to the microprocessor. The host computer securely performs transmission of program information with the microprocessor using the key information stored therein.

According to this construction, the key information that has been written into the nonvolatile memory can not be read from outside or rewritten. In the debug system, the microprocessor and the host computer securely transmit program information to each other using the key information that can not be read from outside or rewritten. Therefore, only the first user to input the key information on the host computer can obtain the program information stored in the microprocessor. As a result, even though a plurality of developers are involved in the development of the system in which the microprocessor is used, only the first user to input the key information can obtain the program information stored in the microprocessor, and debug the operation of the microprocessor with maintaining security.

Here, the present invention may be a microprocessor which is operable to store secret program information and is connected to a host computer that is used to debug the program information in the microprocessor. The microprocessor stores the program information which is one of a program, data and a program and data, and reads the program information to perform an operation corresponding to the read program information. The microprocessor includes a nonvolatile memory which (a) has an area for storing key information that is used to securely handle program information and (b) is writable only once. If no key information is stored in the nonvolatile memory, the microprocessor receives key information from the host computer, and writes the received key information into the nonvolatile memory. The microprocessor securely performs transmission of program information with the host computer using the key information that has been written into the nonvolatile memory. Here, the key information that has been written into the nonvolatile memory is not readable outside of the microprocessor.

According to this construction, once the key information is written into the nonvolatile memory in the microprocessor, the key information is never readable outside of the microprocessor or rewritten. As a consequence, the microprocessor can securely perform transmission of program information with the host computer.

Here, the nonvolatile memory may additionally store therein flag information that indicates whether key information is stored in the nonvolatile memory. The microprocessor may read the flag information, and, if the read flag information indicates that no key information is stored in the nonvolatile memory, receive the key information from the host computer, and write the key information received from the host computer into the nonvolatile memory.

According to this construction, the microprocessor reads the flag in the nonvolatile memory so as to judge whether the key information has been written into the nonvolatile memory.

Here, the microprocessor may encrypt the program information using the key information that has been stored in the nonvolatile memory, and output the encrypted program information.

According to this construction, the program information is encrypted using the key information that has been written into the nonvolatile memory. As described above, once the key information is written into the nonvolatile memory, it is never be readable outside of the microprocessor or rewritten. As a result, the microprocessor can highly securely transmit the program information to the host computer.

Here, the program information stored in the microprocessor may be encrypted program information which is one of an encrypted program, encrypted data, and an encrypted program and encrypted data. The microprocessor may read the key information that has been stored in the nonvolatile memory, decrypt the encrypted program information using the read key information so as to generate decrypted program information which is one of a decrypted program, decrypted data, and a decrypted program and decrypted data, and perform an operation corresponding to the decrypted program information. Also, the transmission performed by the microprocessor may be transmission of encrypted program information.

According to this construction, the program information stored in the microprocessor is encrypted program information. Therefore, the microprocessor can securely perform transmission of the program information with the host computer. When the encrypted program information is decrypted to be executed, the key information stored in the nonvolatile memory is used. Thus, the encrypted program information stored in the microprocessor can be executed.

Here, the microprocessor may encrypt a result of the operation using the key information that has been stored in the nonvolatile memory, and write the encrypted result therein.

According to this construction, the encrypted data stored in the microprocessor is decrypted using the key information and result data generated by a calculation on the decrypted data is again encrypted using the key information. As a result, even when the data stored in the microprocessor is encrypted data, the encrypted data can be executed and security is achieved.

Here, the program stored in the microprocessor may be an encrypted program, and the microprocessor has a path to communicate with an external device.

According to this construction, the microprocessor is connected to the external device. However, since the microprocessor stores an encrypted program, security is achieved. On the other hand, since the microprocessor stores not-encrypted data, the external device can obtain the not-encrypted data as needed.

Here, the key information that has been written into the nonvolatile memory may be constituted by one or more pieces of partial key information. The program stored in the microprocessor may be a plurality of encrypted partial programs each of which corresponds to any of the pieces of partial key information. The microprocessor may (a) read a piece of partial key information from the nonvolatile memory, (b) read one or more of the encrypted partial programs corresponding to the read piece of partial key information, (c) decrypt the read encrypted partial programs using the read piece of partial key information to generate decrypted partial programs, and (d) perform an operation corresponding to the decrypted partial programs.

According to this construction, a different piece of key information is assigned to each encrypted partial program, and each of the developers of the encrypted partial programs sets key information which is not known to the rest of the developers. As a result, each encrypted partial program can be securely transmitted to the host computer.

Here, the microprocessor may inhibit the output of the encrypted program information, in response to a request from the host computer.

According to this construction, even when the microprocessor stores encrypted program information, the output of the encrypted program information to the host computer is inhibited in response to a request from the host computer. As a result, a hostile analyzer is prevented from obtaining the encrypted program information from the microprocessor.

Here, the microprocessor may store an inhibition condition that relates to the key information received from the host computer. If the key information received from the host computer satisfies the inhibition condition, the microprocessor may inhibit the output of the encrypted program information.

According to this construction, even when the microprocessor stores encrypted program information, the output of the encrypted program information to the host computer is inhibited if the key information satisfies the inhibition condition. As a result, a hostile analyzer is prevented from obtaining the encrypted program information from the microprocessor. Here, the microprocessor described above inhibits the output of the encrypted program information in response to a request from the host computer. However, the microprocessor having this construction judges whether to inhibit the output or not on its own. As a consequence, higher-level security is achieved.

Here, the nonvolatile memory may additionally store flag information indicating whether key information is stored in the nonvolatile memory, and the microprocessor may read the flag information. Here, if the read flag information indicates that no key information is stored in the nonvolatile memory, the microprocessor may read the program information, and outputs the read program information. If the read flag information indicates that the key information has been stored in the nonvolatile memory, the microprocessor may read the program information, encrypt the read program information using the key information that has been stored in the nonvolatile memory, and output the encrypted program information.

According to this construction, the microprocessor can output the program information with or without encryption. The microprocessor selects one of these. Thus, when no key information is stored in the nonvolatile memory, a developer of a program can perform a debug operation without involving encryption. Afterwards, a user different from the developer can write key information. This operation is explained taking a service system using an IC card as an example. Developers of a microprocessor to be mounted on an IC card, a program and the IC card obtain program information without involving encryption to perform a debug operation at the development stage. Afterwards, a provider of a service using the IC card writes program information and also writes key information into the nonvolatile memory. Once the key information is written into the nonvolatile memory, only the provider of the service can obtain the program information stored in the microprocessor.

Here, the microprocessor may further include a cache memory. The program information stored in the microprocessor is encrypted program information which is one of an encrypted program, encrypted data, and an encrypted program and encrypted data. The microprocessor may (a) read the key information that has been stored in the nonvolatile memory, (b) decrypt the encrypted program information using the read key information so as to generate decrypted program information which is one of a decrypted program, decrypted data and a decrypted program and decrypted data, (c) write the decrypted program information into the cache memory, (d) read the decrypted program information from the cache memory in accordance with a processing speed of the executing unit, and (e) perform an operation corresponding to the decrypted program information. Here, the transmission performed by the microprocessor is transmission of encrypted program information.

According to this construction, when the time required for decryption of the encrypted program information is short and the time required for executing the decrypted program information is long, the decrypted program information is accumulated in the cache memory so as to be executed without causing problems.

Here, the present invention is a host computer which (i) is connected to a microprocessor operable to store secret program information and (ii) debugs the program information in the microprocessor. The host computer receives key information from a user, stores the received key information therein, and sends the received key information to the microprocessor. The host computer securely performs transmission of program information with the microprocessor using the key information stored therein.

According to this construction, the key information received from the user is sent to the microprocessor, and the program information is transmitted using the key information. As a result, the program information is known only to the user.

Here, the host computer may receive encrypted program information from the microprocessor, decrypt the encrypted program information using the key information stored therein so as to generate decrypted program information, and display the decrypted program information.

According to this construction, the program information can not be decrypted by a person other than the user. As a consequence, the user can securely obtain the program information and perform a debug operation.

Here, the host computer may receive, from the user, program information which is one of a program, data and a program and data, encrypt the program information received from the user, using the key information stored therein so as to generate encrypted program information, and output the encrypted program information to the microprocessor.

According to this construction, the program information received from the user is encrypted so as to be transmitted to the microprocessor. As a result, the program information can be securely transmitted to the microprocessor.

Here, the host computer may store a source program, convert the source program into an object program, encrypt the object program using the key information stored therein so as to generate an encrypted program. Then, the host computer may transmit the encrypted program to the microprocessor.

According to this construction, the host computer compiles the source program to generate an object program. The host computer further encrypts the generated object program, and transmits it to the microprocessor. As a consequence, the object program can be securely written into the microprocessor.

Here, the host computer may store an inhibition condition that relates to the key information. If the key information satisfies the inhibition condition, the host computer may output a request, to the microprocessor, to inhibit the transmission of the encrypted program information.

According to this construction, the host computer stores the inhibition condition, which is a numerical value indicating the number of times different key information is input. Thus, if different key information is input many times, the transmission of encrypted program information between the host computer and the microprocessor can be inhibited. As a result, even though a hostile analyzer inputs different key information many times in an attempt to decrypt the encrypted program information, s/he is prevented from decrypting and falsifying the program information.

### BRIEF DESCRIPTION OF THE DRAWINGS

These and the other objects, advantages and features of the invention will become apparent from the following description thereof taken in conjunction with the accompanying drawings which illustrates a specific embodiment of the invention.

FIG. 1 is a block diagram illustrating a construction of a microprocessor 10.

FIG. 2 is a block diagram illustrating a construction of a host PC 12.

FIG. 3 is a flow chart illustrating an operation of a debug system 1 and the flow chart continues in FIG. 4.

FIG. 4 is a flow chart illustrating an operation of the debug system 1, and the flow chart follows the flow chart shown in FIG. 3.

FIG. 5 is a block diagram illustrating a construction of a microprocessor 20.

FIG. 6 is a block diagram illustrating a construction of a host PC 22.

FIG. 7 is a flow chart illustrating an operation of a debug system 2, and the flow chart follows the flow chart shown in FIG. 3.

FIG. 8 is a block diagram illustrating a construction of a microprocessor 30.

FIG. 9 is a block diagram illustrating a construction of a microprocessor 40.

FIG. 10 is a block diagram illustrating a construction of a host PC 42.

FIG. 11 is a flow chart illustrating an operation of a debug system 4, and the flow chart follows the flow chart shown in FIG. 3.

FIG. 12 is a block diagram illustrating a construction of a host PC 52.

FIG. 13 is a flow chart illustrating an operation of a debug system 5, and the flow chart follows the flow chart shown in FIG. 3.

FIG. 14 is a block diagram illustrating a construction of a microprocessor 60.

FIG. 15 is a block diagram illustrating a construction of a host PC 62.

FIG. 16 is a flow chart illustrating an operation of a debug system 6, and the flow chart continues in FIG. 7.

FIG. 17 is a block diagram illustrating a construction of a microprocessor 70.

FIG. 18 is a block diagram illustrating a construction of a host PC 72.

FIG. 19 is a flow chart illustrating an operation of a debug system 7, and the flow chart continues in FIG. 4 and FIG. 20.

FIG. 20 is a flow chart illustrating an operation of the debug system 7, and the flow chart follows the flow charts in FIG. 19 and FIG. 22.

FIG. 21 is a block diagram illustrating a construction of a microprocessor 80.

FIG. 22 is a flow chart illustrating an operation of a debug system 8, and the flow chart continues in FIG. 4 and FIG. 20.

FIG. 23 is a block diagram illustrating a construction of a microprocessor 90.

FIG. 24 is a flow chart illustrating an operation of a debug system 9, and the flow chart continues in FIG. 4 and FIG. 25.

FIG. 25 is a flow chart illustrating an operation of the debug system 9, and the flow chart follows the flow chart in FIG. 24.

FIG. 26 is a block diagram illustrating a construction of a microprocessor 100.

### DESCRIPTION OF THE PREFERRED EMBODIMENTS

### 1. First Embodiment

A debug system 1 relating to a first embodiment of the present invention is described with reference to the attached figures.

(Construction)

The following part describes the construction of the debug system 1. The debug system 1 is constituted by a microprocessor 10, a debug unit 11, a host PC 12 and an external memory 13.

The microprocessor 10 and the external memory 13 are mounted on the substrate of an IC card that is developed by a user of the debug system 1, and connected to each other by an external bus. The debug unit 11 is connected to the microprocessor 10 and the host PC 12 by a cable. Here, the external memory 13 stores a computer program composed of an instruction and data, and the computer program is executed by the microprocessor 10.

The following part describes the microprocessor 10 and the host PC 12 in detail.

(Microprocessor 10)

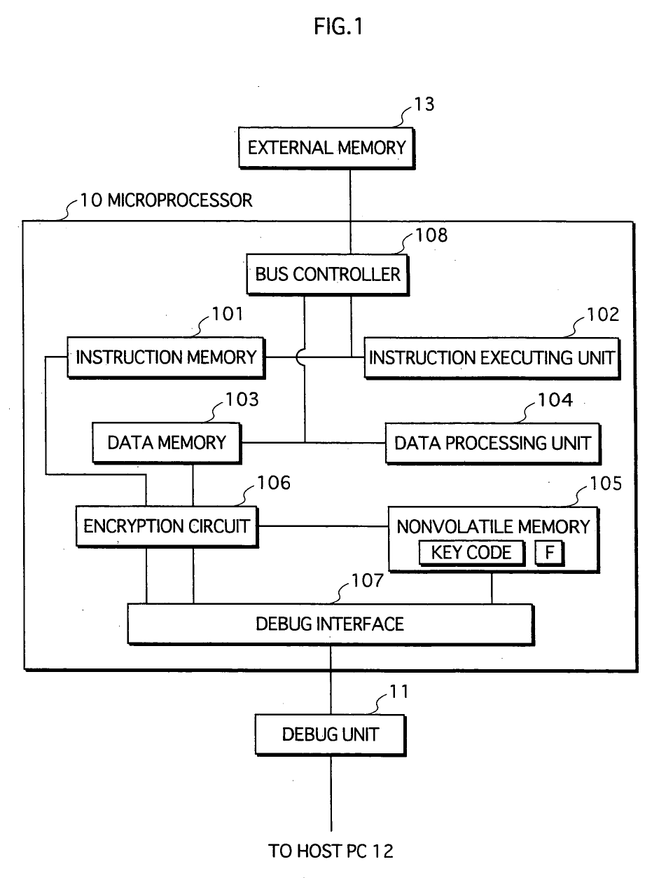

FIG. 1 is a block diagram illustrating a construction of the microprocessor 10. As shown in FIG. 1, the microprocessor 10 is constituted by an instruction memory 101, an instruction executing unit 102, a data memory 103, a data processing unit 104, a nonvolatile memory 105, an encryption circuit 106, a debug interface 107, and a bus controller 108.

The instruction memory 101 is specifically composed of a Random Access Memory (RAM) and a Read Only Memory (ROM), and stores an instruction. The instruction memory 101 is connected to the instruction executing unit 102 by a bus. In addition, the instruction memory 101 is connected to the encryption circuit 106 by a bus. Thus, on reception of a request from a debugger operating on the host PC 12, the instruction memory 101 outputs an instruction stored therein to the encryption circuit 106. In addition, the instruction memory 101 receives and stores an instruction output from the encryption circuit 106.

The instruction executing unit 102 is connected to the instruction memory 101 by a bus. The instruction executing unit 102 reads, interprets and then executes an instruction stored in the instruction memory 101. The instruction executing unit 102 is also connected to the external memory 13 by the bus controller 108 and an external bus. Thus, the instruction executing unit 102 reads an instruction stored in the external memory 13 through the bus controller 108, and interprets and executes the instruction.

The data memory 103 is specifically one of a ROM and a RAM, and stores data. The data memory 103 is connected to the data processing unit 104 by a bus. When the data memory 103 receives a request from the data processing unit 104, the data memory 103 outputs data to the data processing unit 104. The data memory 103 receives and stores calculation results output from the data processing unit 104. The data memory 103 is also connected to the encryption circuit 106 by a bus. Thus, the data memory 103 outputs data stored therein to the encryption circuit 106, in response to a request from the debugger operating on the host PC 12. Also, the data memory 103 receives and stores data output from the encryption circuit 106.

The data processing unit 104 is connected to the data memory 103 by a bus. The data processing unit 104 reads data from the data memory 103, performs a calculation on the read data, and writes a result of the calculation to the data memory 103. The data processing unit 104 is also connected to the external memory 13 by a bus and the bus controller 108. Thus, the data processing unit 104 reads data stored in the external memory 13 through the bus controller 108, performs a calculation on the read data, and writes a result of the calculation to the external memory 13.

The nonvolatile memory 105 has an area for storing a key code and an area storing a judgment flag. When a key code is written, it is stored in the corresponding area in the nonvolatile memory 105. Here, a key code is an encryption key used for encryption of an instruction and data performed by the encryption circuit 106. Once a key code is written into the nonvolatile memory 105, it is never readable outside of the microprocessor 10 or rewritten. A judgment flag is used to judge whether a key code has been written into the nonvolatile memory 105 or not. If a key code is written into the nonvolatile memory 105, a judgment flag in the nonvolatile memory 105 is set. Once a judgment flag is set, it can never be reset afterwards.

The encryption circuit 106 encrypts an instruction and data which is read from the instruction memory 101 or the data memory 103, by the host PC 12, through the debug interface 107 and the debug unit 11. Using a key code stored in the nonvolatile memory 105 as an encryption key, the encryption circuit 106 performs an encryption algorithm E₁ to an instruction stored in the instruction memory 101 and data stored in the data memory 103, to generate an encrypted instruction and encrypted data. The encryption algorithm E₁ is, for example, Data Encryption Standard (DES). The encryption circuit 106 outputs the encrypted instruction and encrypted data to the host PC 12 through the debug interface 107 and the debug unit 11.

The debug interface 107 is an interface including a debug terminal. The debug interface 107 connects the encryption circuit 106 and the debug unit 11, and the nonvolatile memory 105 and the debug unit 11.

When the debug interface 107 receives a signal indicating that an instruction is to be displayed from the host PC 12 through the debug unit 11, the debug interface 107 extracts an instruction from the instruction memory 101 and outputs the extracted instruction to the encryption circuit 106. When the debug interface 107 receives a signal indicating that data is to be displayed, the debug interface 107 extracts data from the data memory 103 and outputs the extracted data to the encryption circuit 106. When the debug interface 107 receives an instruction from the host PC 12 through the debug unit 11, the debug interface 107 writes the received instruction to the instruction memory 101 through the encryption circuit 106. Here, the debug interface 107 requires the encryption circuit 106 to write the received instruction into the instruction memory 101 without encrypting the instruction. When the debug interface 107 receives data from the host PC 12 through the debug unit 11, the debug interface 107 writes the received data into the data memory 103 through the encryption circuit 106. Here, the debug interface 107 requires the encryption circuit 106 to write the received data into the data memory 103 without encrypting the data.

The bus controller 108 performs the transfer of information between the external memory 13 that is disposed outside of the microprocessor 10 and the instruction executing unit 102, and between the external memory 13 and the data processing unit 104.

(Host PC 12)

The host PC 12 is a computer system in which a debugger corresponding to the microprocessor 10 operates. The host PC 12 is specifically constituted by a microprocessor, a ROM, a RAM, a hard disk unit, a display screen, a keyboard, a mouse and the like. The hard disk unit stores various kinds of computer programs including the debugger.

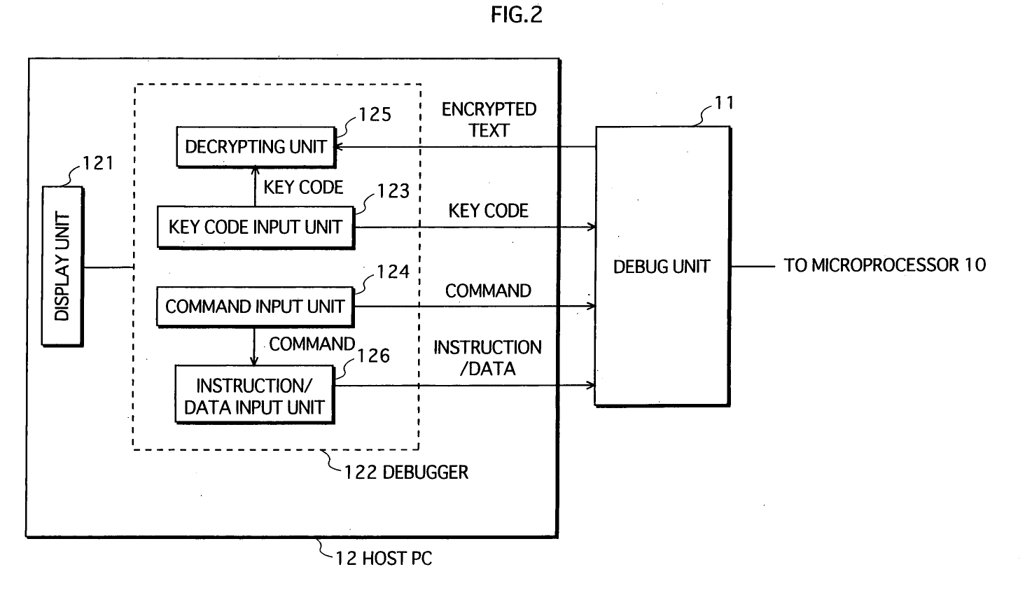

FIG. 2 is a functional block diagram illustrating functions of the host PC 12. As shown in FIG. 2, the host PC 12 includes a display unit 121 and a debugger 122. The debugger 122 functionally describes how the debugger stored in the hard disk unit operates when it is executed by the microprocessor of the host PC 12. The debugger 122 includes a key code input unit 123, a command input unit 124, a decrypting unit 125, and an instruction/data input unit 126.

The display unit 121 includes a display screen, and displays screen page data output from the debugger 122 on the display screen. When a screen page for receiving an input of a key code is displayed on the display screen, the display unit 121 displays what the key code input unit 123 receives on the display screen. Similarly, when a screen page for receiving an input of a command is displayed on the display screen, the display unit 121 displays what the command input unit 124 receives on the display screen. When a screen page for receiving an input of an instruction is displayed on the display screen, the display unit 121 displays what the instruction/data input unit 126 receives on the display screen. When a screen page for receiving an input of data is displayed on the display screen, the display unit 121 displays what the instruction/data input unit 126 receives on the display screen.

The key code input unit 123 outputs screen page information to generate a screen page for receiving an input of a key code, to the display unit 121. When a screen page for receiving an input of a key code is displayed on the display unit 121, the key code input unit 123 receives an input of a key code by a user's operation using the keyboard and the mouse. The key code input unit 123 stores therein the received key code. The key code input unit 123 reads a judgment flag in the nonvolatile memory 105 through the debug unit 11 and the debug interface 107 of the microprocessor 10, and then judges whether a key code has been written into the nonvolatile memory 105. If a key code has not been written, the key code input unit 123 sends the received key code to the nonvolatile memory 105 through the debug unit 11 and the debug interface 107. Here, the key code input unit 123 discards the key code stored therein if an operation of the debugger 122 is ended.

The command input unit 124 outputs screen page information to generate a screen page for receiving an input of a command to the display unit 121. When a screen page for receiving an input of a command is displayed on the display unit 121, the command input unit 124 receives an input of a command by a user's operation using the keyboard and the mouse. Then, the command input unit 124 reads the received command. When the received command is an instruction displaying command, the command input unit 124 sends a signal indicating that an instruction is to be displayed to the debug interface 107 through the debug unit 11. When the received command is an instruction writing command, the command input unit 124 sends a signal corresponding to the command to the instruction/data input unit 126. When the received command is a data displaying command, the command input unit 124 sends a signal indicating that data is to be displayed to the debug interface 107 through the debug unit 11. When the received command is a data writing command, the command input unit 124 outputs a signal corresponding to the command to the instruction/data input unit 126. When the received command is an end command, the operation of the host PC 12 ends.

The decrypting unit 125 receives an encrypted instruction generated by the encryption circuit 106, from the encryption circuit 106 through the debug unit 11 and the debug interface 107. The decrypting unit 125 reads a key code stored in the key code input unit 123. Using the read key code as a decryption key, the decrypting unit 125 performs a decryption algorithm D₁ to the received encrypted instruction, to generate a decrypted instruction. The decryption algorithm D₁ is an algorithm to decrypt an encrypted text generated using the encryption algorithm E₁. The decrypting unit 125 outputs the decrypted instruction to the display unit 121. Similarly, the decrypting unit 125 receives encrypted data generated by the encryption circuit 106, from the encryption circuit 106 through the debug unit 11 and the debug interface 107. Then, the decrypting unit 125 reads a key code stored in the key code input unit 123. Using the read key code as an decryption key, the decrypting unit 125 performs the decryption algorithm D₁ to the received encrypted data to generate decrypted data. The decrypting unit 125 outputs the decrypted data to the display unit 121.

Here, if a key code received by the key code input unit 123 is the same as a key code that has been stored in the nonvolatile memory 105, the host PC 12 can properly decrypt an encrypted instruction and encrypted data obtained from the microprocessor 10.

The instruction/data input unit 126 outputs screen page information to generate a screen page for receiving an input of an instruction to the display unit 121, when the instruction/data input unit 126 receives a signal indicating that an instruction is to be written from the command input unit 124. When a screen page for receiving an input of an instruction is displayed on the display unit 121, the instruction/data input unit 126 receives an input of an instruction by a user's operation using the keyboard. The instruction/data input unit 126 outputs the received instruction to the debug interface 107 through the debug unit 11. When the instruction/data input unit 126 receives a signal indicating that data is to be written from the command input unit 124, the instruction/data input unit 126 outputs screen page information to generate a screen page for receiving an input of data to the display unit 121. When a screen page for receiving an input of data is displayed on the display unit 121, the instruction/data input unit 126 receives an input of data by a user's operation using the keyboard. The instruction/data input unit 126 sends the received data to the debug interface 107 through the debug unit 11.

(Operations)

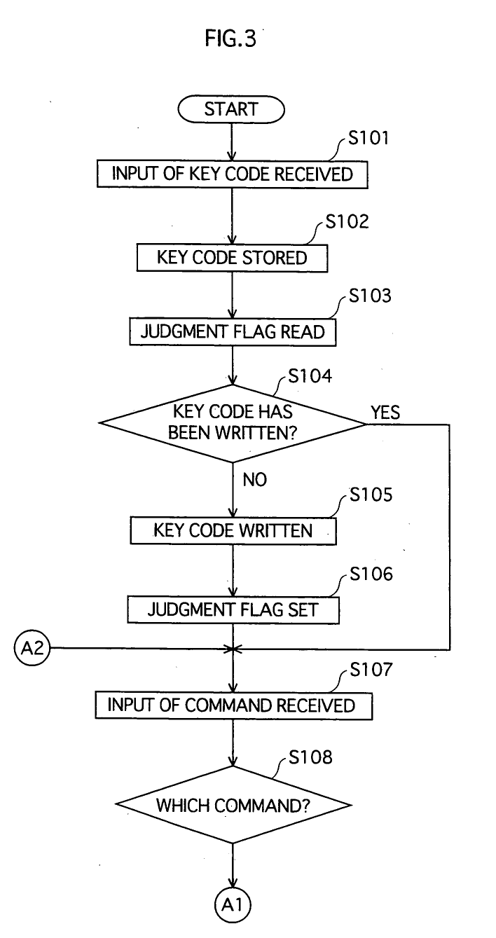

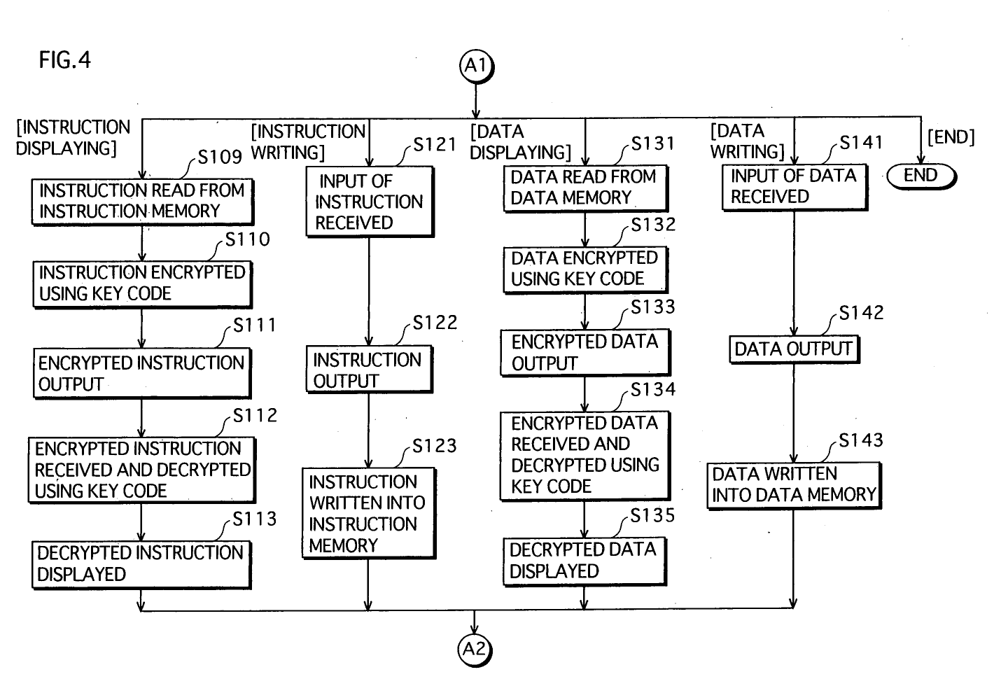

The following part describes the operation of the debug system 1 with reference to the flow charts in FIGS. 3 and 4.

The debugger 122 of the host PC 12 is activated, and the key code input unit 123 receives an input of a key code from a user (step S101). The key code input unit 123 stores therein the received key code (step S102). The key code input unit 123 retrieves a judgment flag from the nonvolatile memory 105 of the microprocessor 10 through the debug unit 11, and reads the retrieved judgment flag so as to judge whether a key code has been written into the nonvolatile memory 105 (step S103). If a key code has not been written (NO: step S104), the key code input unit 123 writes the key code stored therein into the nonvolatile memory 105 through the debug unit 11 and the debug interface 107 (step S105). After this, the key code input unit 123 sets a judgment flag in the nonvolatile memory 105, to indicate a key code has been written into the nonvolatile memory 105 (step S106).

After this, the command input unit 124 of the host PC 12 receives an input of a command from the user (step S107). Here, the user selects and inputs one of an instruction displaying command, an instruction writing command, a data displaying command, a data writing command, and an end command. The command input unit 124 reads the received command (step S108).

When the received command is an instruction displaying command (INSTRUCTION DISPLAYING: step S108), the command input unit 124 sends a signal to the debug interface 107. The debug interface 107 extracts an instruction from the instruction memory 101 (step S109) and outputs the extracted instruction to the encryption circuit 106. The encryption circuit 106 receives the instruction, and encrypts the received instruction using a key code stored in the nonvolatile memory 105 (step S110). The encryption circuit 106 outputs the encrypted instruction to the host PC 12 through the debug interface 107 and the debug unit 11 (step S111). The decrypting unit 125 of the host PC 12 receives the encrypted instruction, and decrypts the encrypted instruction using the key code stored in the key code input unit 123 in the step S102 (step S112). The decrypting unit 125 outputs the decrypted instruction to the display unit 121, and the display unit 121 displays the decrypted instruction on the display screen (step S113). Here, if the key code input in the step S101 is the same as the key code stored in the nonvolatile memory 105, the instruction is properly displayed. If those key codes are not the same, the instruction is not properly displayed. After this, the procedure of the debug system 1 goes back to the step S107 and continues.

When the received command is an instruction writing command (INSTRUCTION WRITING: step S108), the instruction/data input unit 126 of the host PC 12 receives an input of an instruction from the user (step S121). The instruction/data input unit 126 sends the received instruction to the debug interface 107 through the debug unit 11, and the debug interface 107 outputs the instruction to the encryption circuit 106 (step S122). The encryption circuit 106 receives the instruction from the debug interface 107, and writes the instruction into the instruction memory 101 (step S123). Here, the encryption circuit 106 writes the instruction into the instruction memory 101 without encrypting the instruction. After this, the procedure of the debug system 1 goes back to the step S107 and continues.

When the received command is a data displaying command (DATA DISPLAYING: step S108), the command input unit 124 sends a signal to the debug interface 107. The debug interface 107 extracts data stored in the data memory 103 (step S131), and outputs the extracted data to the encryption circuit 106. The encryption circuit 106 receives the data from the debug interface 107, and encrypts the data using a key code stored in the nonvolatile memory 105 (step S132). The encryption circuit 106 outputs the encrypted data to the host PC 12 through the debug interface 107 and the debug unit 11 (step S133). The decrypting unit 125 of the host PC 12 receives the encrypted data, and decrypts the data using the key code stored in the key code input unit 123 in the step S102 (step S134). The decrypting unit 125 outputs the decrypted data to the display unit 121, and the display unit 121 displays the decrypted data on the display screen (step S135). Here, if the key code input in the step S101 is the same as the key code stored in the nonvolatile memory 105, the data is properly displayed. If these key codes are not the same, the data is not properly displayed. After this, the procedure of the debug system 1 goes back to the step S107 and continues.

When the received command is a data writing command (DATA WRITING: step S108), the instruction/data input unit 126 of the host PC 12 receives an input of data from the user (step S141). The instruction/data input unit 126 sends the received data to the debug interface 107 through the debug unit 11, and the debug interface 107 outputs the data to the encryption circuit 106 (step S142). The encryption circuit 106 receives the data from the debug interface 107, and writes the data into the data memory 103 (step S143). Here, the encryption circuit 106 writes the data into the data memory 103 without encrypting the data. After this, the procedure of the debug system 1 goes back to the step S107 and continues.

When the received command is an end command (END: step S108), the operation of the host PC 12 ends.

### 2. Second Embodiment

A debug system 2 relating to a second embodiment of the present invention is described with reference to the attached figures.

(Construction)

The following part describes the construction of the debug system 2. The debug system 2 is constituted by a microprocessor 20, a debug unit 21, and a host PC 22. The microprocessor 20 is mounted on the substrate of an IC card that is developed by a user of the debug system 2. The debug unit 21 is connected to the microprocessor 20 and the host PC 22 by a cable.

The following part describes the microprocessor 20 and the host PC 22 in detail.

(Microprocessor 20)

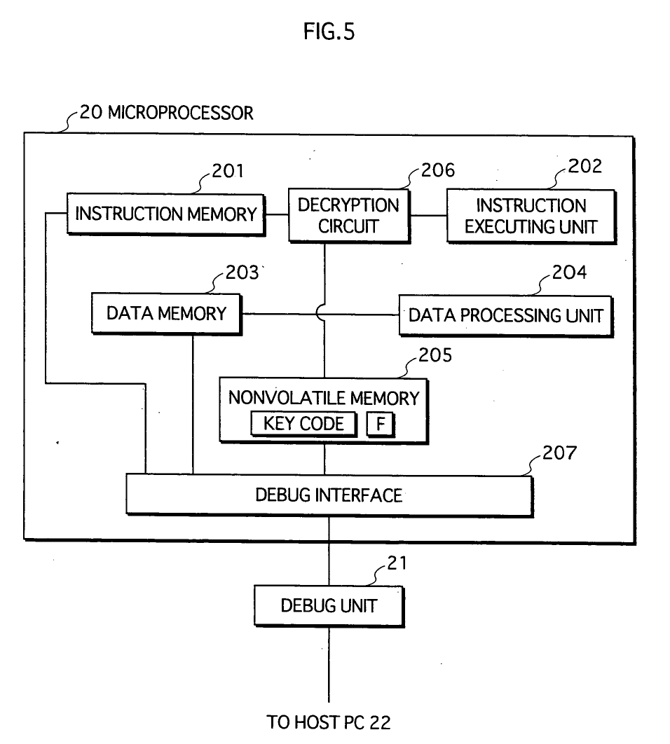

FIG. 5 is a block diagram illustrating a construction of the microprocessor 20. As shown in FIG. 5, the microprocessor 20 is constituted by an instruction memory 201, an instruction executing unit 202, a data memory 203, a data processing unit 204, a nonvolatile memory 205, a decryption circuit 206, and a debug interface 207.

The instruction memory 201 is specifically composed of a RAM and a ROM, and stores an encrypted instruction. An encrypted instruction stored in the instruction memory 201 is generated beforehand in such a manner that a compiler 224 of the host PC 22 (mentioned later) performs an encryption algorithm E₂ to an instruction. The instruction memory 201 is connected to the decryption circuit 206 by a bus, and also to the debug interface 207 by a bus. Thus, on reception of a request from a debugger operating on the host PC 22, the instruction memory 201 outputs an encrypted instruction stored therein to the host PC 22 through the debug interface 207 and the debug unit 21. Also, the instruction memory 201 receives and stores an encrypted instruction output from the debug interface 207.

The instruction executing unit 202 is connected to the decryption circuit 206 by a bus. The instruction executing unit 202 receives, interprets and executes an instruction from the decryption circuit 206.

The data memory 203 is specifically one of a ROM and a RAM, and stores data. The data memory 203 is connected to the data processing unit 204 by a bus. When the data memory 203 receives a request from the data processing unit 204, the data memory 203 outputs data to the data processing unit 204. The data memory 203 receives and stores calculation results output from the data processing unit 204. The data memory 203 is connected to the debug interface 207 by a bus. The data memory 203 outputs data stored therein to the debug interface 207, on reception of a request from the debugger operating on the host PC 22. Also, the data memory 203 receives and stores data output from the debug interface 207.

The data processing unit 204 is connected to the data memory 203 by a bus. The data processing unit 204 reads data from the data memory 203, performs a calculation on the read data, and writes the result of the calculation to the data memory 203.

The nonvolatile memory 205 has an area for storing a key code and an area storing a judgment flag. When a key code is written, it is stored in the corresponding area in the nonvolatile memory 205. Here, a key code is a decryption key used for decryption of an encrypted instruction performed by the decryption circuit 206. Once a key code is written into the nonvolatile memory 205, it is never readable outside of the microprocessor 20 or rewritten. A judgment flag is used to judge whether a key code has been written into the nonvolatile memory 205 or not. If a key code is written into the nonvolatile memory 205, a judgment flag in the nonvolatile memory 205 is set. Once a judgment flag is set, it can not be reset afterwards.

The decryption circuit 206 decrypts an encrypted instruction, which is read, by the instruction executing unit 202, from the instruction memory 201. Using a key code stored in the nonvolatile memory 205 as a decryption key, the decryption circuit 206 performs a decryption algorithm D₂ to an encrypted instruction stored in the instruction memory 201, to generate a decrypted instruction. The decryption algorithm D₂ is an algorithm to decrypt an encrypted text generated using the encryption algorithm E₂. The decryption circuit 206 outputs the decrypted instruction to the instruction executing unit 202.

The debug interface 207 is an interface including a debug terminal to connect the microprocessor 20 and the debug unit 21. The debug interface 207 connects the instruction memory 201 and the debug unit 21, the data memory 203 and the debug unit 21, and the nonvolatile memory 205 and the debug unit 21.

When the debug interface 207 receives a signal indicating that an instruction is to be displayed from the host PC 22 through the debug unit 21, the debug interface 207 extracts an encrypted instruction from the instruction memory 201. When the debug interface 207 receives a signal indicating that data is to be displayed, the debug interface 207 extracts data from the data memory 203, and outputs the extracted data to the debug unit 21. When the debug interface 207 receives an encrypted instruction from the host PC 22 through the debug unit 21, the debug interface 207 writes the received encrypted instruction to the instruction memory 201. When the debug interface 207 receives data, the debug interface 207 writes the received data into the data memory 203.

(Host PC 22)

The host PC 22 is a computer system in which a compiler and a debugger corresponding to the microprocessor 20 operate. The host PC 22 is specifically constituted by a microprocessor, a ROM, a RAM, a hard disk unit, a display screen, a keyboard, a mouse and the like. The hard disk unit stores various kinds of computer programs including the debugger and the compiler.

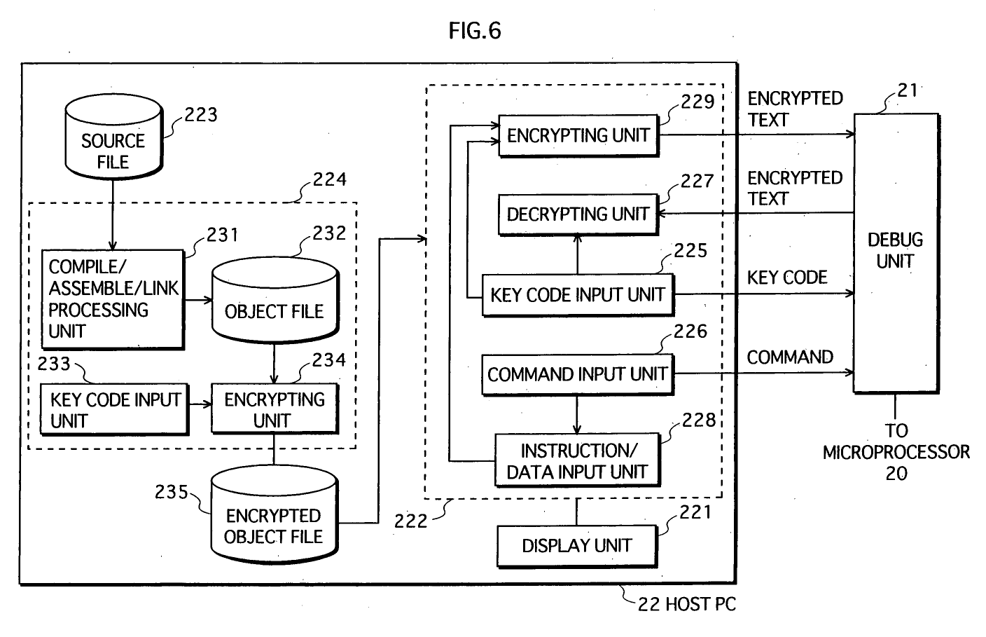

FIG. 6 is a block diagram illustrating a construction of the host PC 22. As shown in FIG. 6, the host PC 22 includes a display unit 221 and a debugger 222, a source file 223, a compiler 224 and an encrypted object file 235. The debugger 222 functionally describes how the debugger stored in the hard disk unit operates when it is executed by the microprocessor of the host PC 22. The debugger 222 includes a key code input unit 225, a command input unit 226, a decrypting unit 227, an instruction/data input unit 228, and an encrypting unit 229.

The compiler 224 functionally describes how the compiler stored in the hard disk unit operates when it is executed by the microprocessor of the host PC 22. The compiler 224 includes a compile/assemble/link processing unit 231, an object file 232, and a key code input unit 233, and an encrypting unit 234.

The display unit 221 includes a display screen, and displays screen page data output from the debugger 222 on the display screen. When a screen page for receiving an input of a key code is displayed on the display screen, the display unit 221 displays what the key code input unit 225 receives on the display screen. When a screen page for receiving an input of a command is displayed on the display screen, the display unit 221 displays what the command input unit 226 receives on the display screen. When a screen page for receiving an input of an instruction is displayed on the display screen, the display unit 221 displays what the instruction/data input unit 228 receives on the display screen. When a screen page for receiving an input of data is displayed on the display screen, the display unit 221 displays what the instruction/data input unit 228 receives on the display screen.

The key code input unit 225 outputs screen page information to generate a screen page for receiving an input of a key code, to the display unit 221. When a screen page for receiving an input of a key code is displayed on the display unit 221, the key code input unit 225 receives an input of a key code by a user's operation using the keyboard and the mouse. The key code input unit 225 stores therein the received key code. After this, the key code input unit 225 reads a judgment flag in the nonvolatile memory 205 through the debug unit 21 and the debug interface 207 of the microprocessor 20, and then judges whether a key code has been written into the nonvolatile memory 205 or not. If a key code has not been written, the key code input unit 225 sends the received key code to the nonvolatile memory 205 through the debug unit 21 and the debug interface 207. The key code input unit 225 discards the key code stored therein if an operation of the debugger 222 is ended.

The command input unit 226 outputs screen page information to generate a screen page for receiving an input of a command, to the display unit 221. When a screen page for receiving an input of a command is displayed on the display unit 221, the command input unit 226 receives an input of a command by a user's operation using the keyboard and the mouse. In addition, the command input unit 226 reads the received command. When the received command is an instruction displaying command, the command input unit 226 sends a signal indicating that an instruction is to be displayed, to the debug interface 207 through the debug unit 21. When the received command is an instruction writing command, the command input unit 226 sends a signal corresponding to the command to the instruction/data input unit 228. When the received command is a data displaying command, the command input unit 226 sends a signal indicating that data is to be displayed, to the debug interface 207 through the debug unit 21. When the received command is a data writing command, the command input unit 226 sends a signal corresponding to the command to the instruction/data input unit 228. When the received command is an end command, the operation of the host PC 22 ends.

The decrypting unit 227 receives an encrypted instruction from the instruction memory 201 through the debug unit 21 and the debug interface 207. In addition, the decrypting unit 227 reads a key code stored in the key code input unit 225. Using the read key code as a decryption key, the decrypting unit 227 performs the decryption algorithm D₂ to the received encrypted instruction, to generate a decrypted instruction. The decrypting unit 227 outputs the decrypted instruction to the display unit 221.

Here, if a key code received by the key code input unit 225 is the same as a key code stored in the nonvolatile memory 205, the host PC 22 can properly decrypt an encrypted instruction obtained from the microprocessor 20.

The instruction/data input unit 228 outputs screen page information to generate a screen page for receiving an input of an instruction to the display unit 221, on reception of a signal corresponding to an instruction writing command from the command input unit 226. When a screen page for receiving an input of an instruction is displayed on the display unit 221, the instruction/data input unit 228 receives an input of an instruction by a user's operation using the keyboard. The instruction/data input unit 228 outputs the received instruction to the encrypting unit 229. When the instruction/data input unit 228 receives a signal corresponding to a data writing command from the command input unit 226, the instruction/data input unit 228 outputs screen page information to generate a screen page for receiving an input of data to the display unit 221. When a screen page for receiving an input of data is displayed on the display unit 221, the instruction/data input unit 228 receives an input of data by a user's operation using the keyboard. The instruction/data input unit 228 sends the received data to the debug interface 207 through the debug unit 21.

The encrypting unit 229 receives an instruction from the instruction/data input unit 228, and reads a key code stored in the key code input unit 225. Using the read key code as an encryption key, the encrypting unit 229 performs the encryption algorithm E₂ to the received instruction, to generate an encrypted instruction. The encrypting unit 229 sends the encrypted instruction to the debug interface 207 through the debug unit 21.

The compile/assemble/link processing unit 231 reads the source file 223 from an external storage device, and performs compile/assemble/link processing to the source file 223, to generate the object file 232. Then the key code input unit 233 receives an input of a key code through the keyboard and the mouse, and stores the received key code therein. Using the key code stored in the key code input unit 233 as an encryption key, the encrypting unit 234 performs the encryption algorithm E₂ to the object file 232, to generate the encrypted object file 235. The compiler 224 writes the encrypted object file 235 into the external storage device.

(Operation)

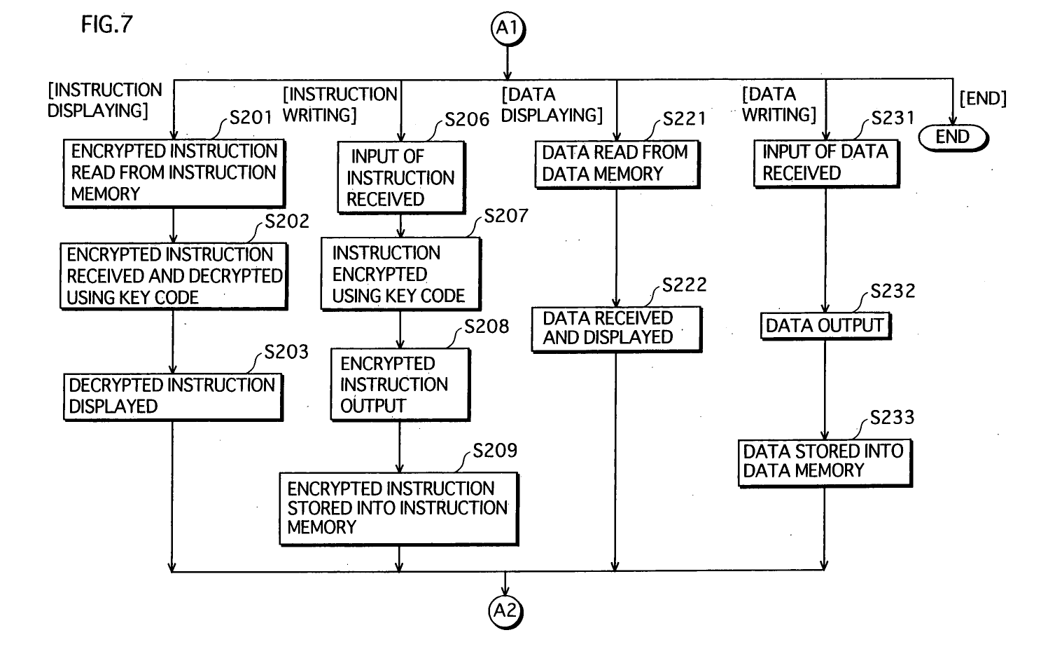

The following part describes the operation of the debug system 2 with reference to the flow charts in FIGS. 3 and 7.

The steps S101 to S108 in FIG. 3 are common to the operations of the debug systems 1 and 2. Therefore, the explanation on these steps is not provided here. The steps shown in FIG. 7 are described in the following part.

When the received command is an instruction displaying command (INSTRUCTION DISPLAYING: step S108), the debugger 222 sends a signal corresponding to the command to the debug interface 207 through the debug unit 21. The debug interface 207 reads an encrypted instruction stored in the instruction memory 201, and outputs the encrypted instruction to the decrypting unit 227 through the debug unit 21 (step S201). The decrypting unit 227 receives the encrypted instruction, and decrypts the encrypted instruction using a key code that is received by the key code input unit 225, to generate a decrypted instruction (step S202). The decrypting unit 227 outputs the decrypted instruction to the display unit 221. The display unit 221 receives the instruction and displays it on the display screen (step S203). After this, the procedure of the debug system 2 goes back to the step S107 shown in FIG. 3 and continues.

When the received command is an instruction writing command (INSTRUCTION WRITING: step S108), the instruction/data input unit 228 of the host PC 22 receives an input of an instruction from the user (step S206). The instruction/data input unit 228 sends the received instruction to the encrypting unit 229. The encrypting unit 229 reads a key code stored in the key code input unit 225, and encrypts the instruction using the read key code as an encryption key (step S207). The encrypting unit 229 sends the encrypted instruction to the debug interface 207 through the debug unit 21 (step S208). The debug interface 207 receives the encrypted instruction, and stores it into the instruction memory 201 (step S209). After this, the procedure of the debug system 2 goes back to the step S107 and continues.

When the received command is a data displaying command (DATA DISPLAYING: step S108), the debugger 222 of the host PC 22 sends a signal corresponding to the command to the debug interface 207 through the debug unit 21. The debug interface 207 reads data stored in the data memory 203, and outputs the read data to the display unit 221 through the debug unit 21 (step S221). The display unit 221 receives and displays the data on the display screen (step S222). After this, the procedure of the debug system 2 goes back to the step S107 and continues.

When the received command is a data writing instruction (DATA WRITING: step S108), the instruction/data input unit 228 of the host PC 22 receives an input of data from the user (step S231). The instruction/data input unit 228 sends the received data to the debug interface 207 through the debug unit 21 (step S232). The debug interface 207 receives the data and stores it in the data memory 203 (step S233). After this, the procedure of the debug system 2 goes back to the step S107 and continues.

When the received command is an end command (END: step S108), the operation of the host PC 22 ends.

### MODIFICATION EXAMPLE 1

A debug system 3, which is a modification example of the debug system 2, is described.

(Construction)

The debug system 3 is constituted by a microprocessor 30, a debug unit 31, a host PC 32 and an external memory 33. The microprocessor 30 and the external memory 33 are mounted on the substrate of an IC card that is developed by a user of the debug system 3, and connected to each other by an external bus. The debug unit 31 is connected to the microprocessor 30 and the host PC 32 by a cable. Here, the external memory 33 stores data and an encrypted instruction. An encrypted instruction is beforehand generated in such a manner that the encryption algorithm E₂ is performed to an instruction using the same key code as the one stored in the nonvolatile memory 305 of the microprocessor 30. An encrypted instruction is decrypted and executed by the microprocessor 30.

The debug system 3 is different from the debug system 2 in that the external memory 33 is connected to the microprocessor 30. The construction of the host PC 32 is not illustrated, because the host PC 32 has the same construction and functions as the host PC 22 in the debug system 2. Therefore, the construction of the host PC 32 is not described here. The following part describes the microprocessor 30 with focus on its difference from the microprocessor 20.

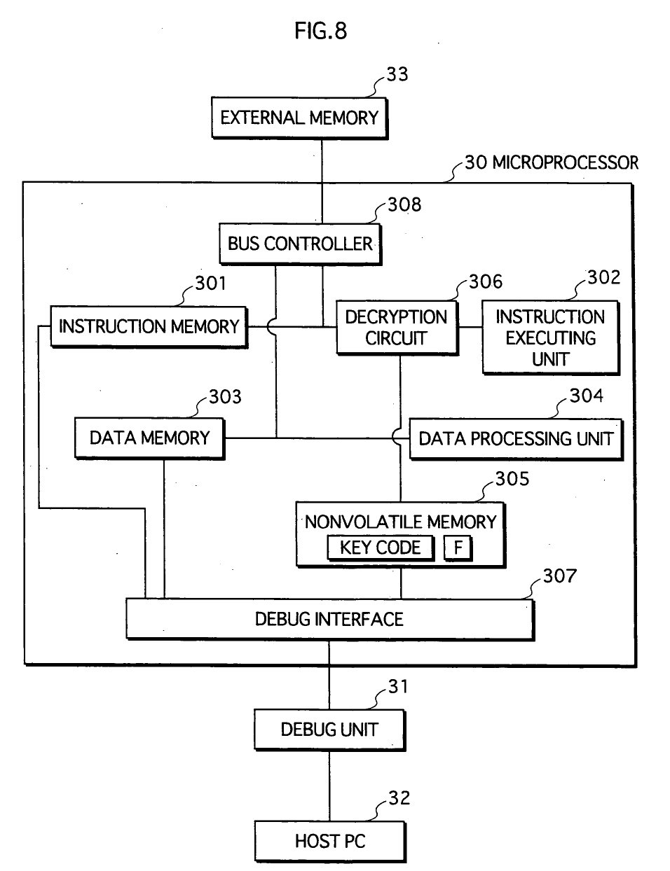

FIG. 8 is a block diagram illustrating a construction of the microprocessor 30. As shown in FIG. 8, the microprocessor 30 is constituted by an instruction memory 301, an instruction executing unit 302, a data memory 303, a data processing unit 304, a nonvolatile memory 305, a decryption circuit 306, a debug interface 307, and a bus controller 308.

The instruction memory 301, the data memory 303, the nonvolatile memory 305, and the debug interface 307 have the same functions as the instruction memory 201, the data memory 203, the nonvolatile memory 205, and the debug interface 207 respectively. Therefore, the explanation on these constituents is not provided here.

The instruction executing unit 302 is connected to the decryption circuit 306 by a bus. The instruction executing unit 302 receives, interprets and executes an instruction from the decryption circuit 306. Here, an instruction that the instruction executing unit 302 receives from the decryption circuit 306 is generated by decrypting an encrypted instruction stored in the instruction memory 301 or in the external memory 33.

The data processing unit 304 is connected to the data memory 303 by a bus. The data processing unit 304 reads data from the data memory 303, performs a calculation on the read data, and writes the result of the calculation to the data memory 303. Also, the data processing unit 304 is connected to the external memory 33 by a bus and the bus controller 308. Thus, the data processing unit 304 reads data stored in the external memory 33 through the bus controller 308, performs a calculation on the read data, and writes the result of the calculation to the external memory 33.

The decryption circuit 306 performs the decryption algorithm D₂ to an encrypted instruction stored in the instruction memory 301 using a key code stored in the nonvolatile memory 305 as a decryption key, to generate a decrypted instruction. Also, the decryption circuit 306 performs the decryption algorithm D₂ to an encrypted instruction stored in the external memory 33, to generate a decrypted instruction. The decryption algorithm D₂ is an algorithm to decrypt an encrypted text generated using the encryption algorithm E₂. The decryption circuit 306 outputs a decrypted instruction to the instruction executing unit 302.

The bus controller 308 performs transfer of information between the external memory 33 that is disposed outside of the microprocessor 30 and the instruction executing unit 302, and between the external memory 33 and the data processing unit 304.

The operation of the debug system 3 is the same as that of the debug system 2 illustrated in FIGS. 3 and 7. Therefore, the explanation on the operation of the debug system 3 is not provided here.

### MODIFICATION EXAMPLE 2

A debug system 4, which is a modification example of the debug system 2, is explained.

(Construction)

The debug system 4 is constituted by a microprocessor 40, a debug unit 41, and a host PC 42. The microprocessor 40 is mounted on the substrate of an IC card that is developed by a user of the debug system 4. The debug unit 41 is connected to the microprocessor 40 and the host PC 42 by a cable.

The debug system 4 is different from the debug system 2 in that the microprocessor 40 stores therein encrypted data, which is generated by performing the encryption algorithm E₂ to data and in that the microprocessor 40 decrypts encrypted data to perform data processing. The microprocessor 40 performs the encryption algorithm E₂ to a calculation result obtained by data processing, to generate encrypted data, and stores the encrypted data therein. The following part describes the microprocessor 40 with focus on its difference from the microprocessor 20.

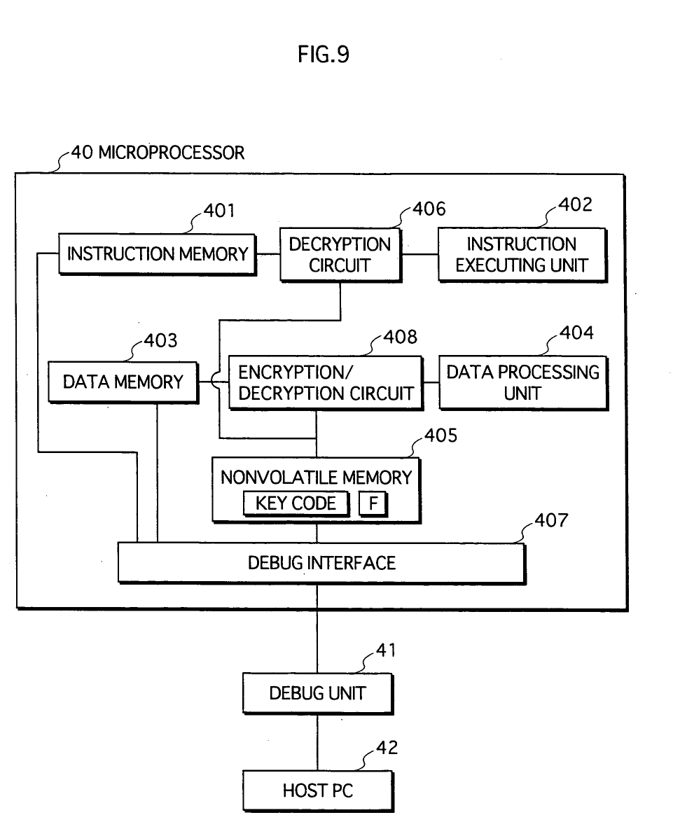

FIG. 9 is a block diagram illustrating a construction of the microprocessor 40. As shown in FIG. 9, the microprocessor 40 is constituted by an instruction memory 401, an instruction executing unit 402, a data memory 403, a data processing unit 404, a nonvolatile memory 405, an decryption circuit 406, a debug interface 407, and an encryption/decryption circuit 408.

The instruction memory 401, the instruction executing unit 402, and the debug interface 407 have the same functions as the instruction memory 201, the instruction executing unit 202, and the debug interface 207 respectively. Therefore, the explanation of these constituents is not provided here.

The data memory 403 is specifically one of a ROM and a RAM, and stores encrypted data, which is generated in such a manner that the encryption algorithm E₂ is performed to data using the same key code as the one stored in the nonvolatile memory 405 as an encryption key. The data memory 403 is connected to the encryption/decryption circuit 408 by a bus. When the data memory 403 receives a request from the data processing unit 404, the data memory 403 outputs encrypted data to the encryption/decryption circuit 408. In addition, the data memory 403 receives and stores calculation results that have been encrypted by the encryption/decryption circuit 408. The data memory 403 is also connected to the debug interface 407 by a bus. The data memory 403 outputs encrypted data stored therein to the debug interface 407, on reception of a request from a debugger operating on the host PC 42. Also, the data memory 403 receives and stores encrypted data output from the debug interface 407.

The data processing unit 404 is connected to the encryption/decryption circuit 408 by a bus. The data processing unit 404 receives data from the encryption/decryption circuit 408, performs a calculation on the received data, and outputs the result of the calculation to the encryption/decryption circuit 408.

The decryption circuit 406 is connected to the instruction memory 401 and the nonvolatile memory 405 by a bus. The decryption circuit 406 receives an encrypted instruction from the instruction memory 401. The decryption circuit 406 reads a key code stored in the nonvolatile memory 405. Using the read key code as an decryption key, the decryption circuit 406 performs the decryption algorithm D₂ to the encrypted instruction, to generate a decrypted instruction. The decryption algorithm D₂ is an algorithm to decrypt an encrypted text generated using the encryption algorithm E₂. The decryption circuit 406 outputs a decrypted instruction to the instruction executing unit 402.

The encryption/decryption circuit 408 is constituted by an encryption circuit and a decryption circuit. When the encryption/decryption circuit 408 receives encrypted data from the data memory 403, the encryption/decryption circuit 408 uses the decryption circuit therein to generate decrypted data and outputs the decrypted data to the data processing unit 404. When the encryption/decryption circuit 408 receives data from the data processing unit 404, the encryption/decryption circuit 408 uses the encryption circuit therein to generate encrypted data and outputs the encrypted data to the data memory 403.

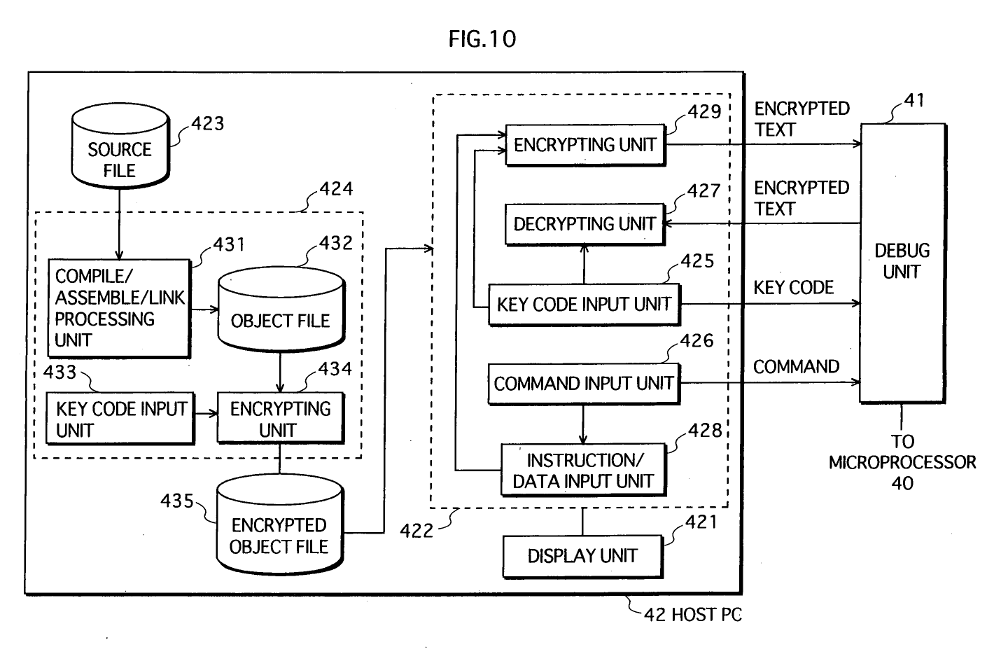

The host PC 42 is a personal computer in which a compiler and a debugger corresponding to the microprocessor 40 operate. As shown in FIG. 10, the host PC 42 includes a display unit 421, a debugger 422, a source file 423, and a compiler 424. The debugger 422 functionally describes the debugger operating on the host PC 42. The debugger 422 includes a key code input unit 425, a command input unit 426, a decrypting unit 427, an instruction/data input unit 428, and an encrypting unit 429. The compiler 424 functionally describes the compiler, an assembler, and a linker operating on the host PC 42. The compiler 424 includes a compile/assemble/link processing unit 431, an object file 432, a key code input unit 433, and an encrypting unit 434. The host PC 42 has the same functions as the host PC 22. Therefore, detailed explanation on the host PC 42 is not provided here.

(Operation)

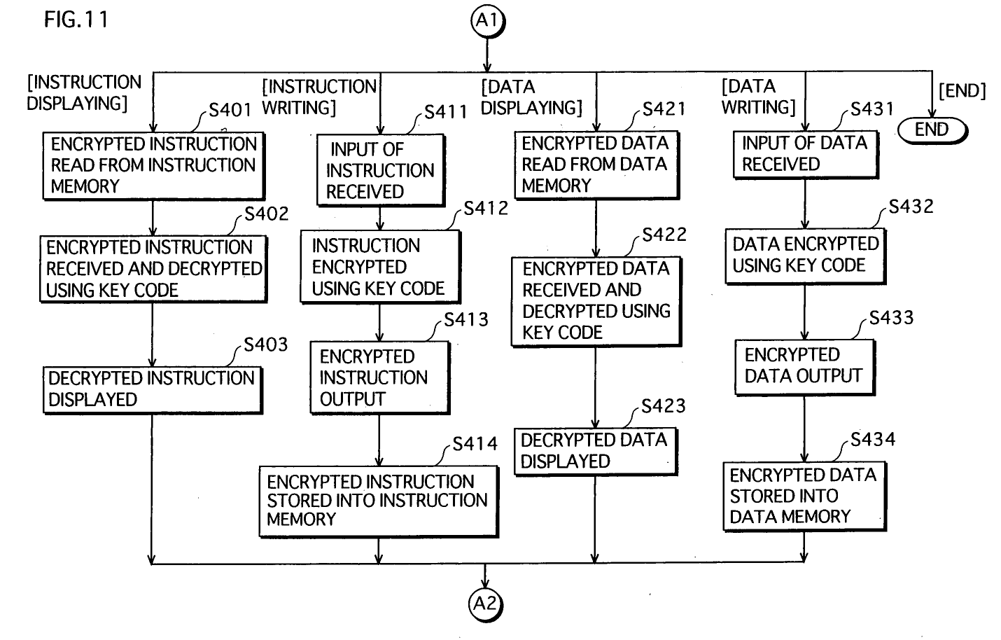

The following part describes the operation of the debug system 4 with reference to the flow charts shown in FIGS. 3 and 11.

The steps S101 to S108 in FIG. 3 are common to the operations of the debug systems 1 and 4. Therefore, the explanation on these steps is not provided here. The steps shown in FIG. 11 are described in the following part.

When the received command is an instruction displaying command (INSTRUCTION DISPLAYING: step S108), the debugger 422 of the host PC 42 sends a signal corresponding to the command to the debug interface 407 through the debug unit 41. The debug interface 407 reads an encrypted instruction stored in the instruction memory 401 and outputs the encrypted instruction to the decrypting unit 427 through the debug unit 41 (step S401). The decrypting unit 427 receives the encrypted instruction from the debug interface 407 through the debug unit 41, and decrypts the encrypted instruction using a key code received by the key code input unit 425, to generate a decrypted instruction (step S402). The decrypting unit 427 outputs the decrypted instruction to the display unit 421, and the display unit 421 displays the decrypted instruction on the display screen (step S403). After this, the procedure of the debug system 4 goes back to the step S107 in FIG. 3 and continues.

When the received command is an instruction writing command (INSTRUCTION WRITING: step S108), the instruction/data input unit 428 of the host PC 42 receives an input of an instruction from the user (step S411). The instruction/data input unit 428 outputs the received instruction to the encrypting unit 429. The encrypting unit 429 reads a key code stored in the key code input unit 425, and uses the read key code as an encryption key to encrypt the instruction (step S412). The encrypting unit 429 sends the encrypted instruction to the debug interface 407 through the debug unit 41 (step S413). The debug interface 407 receives the encrypted instruction, and stores it into the instruction memory 401 (step S414). After this, the procedure of the debug system 4 goes back to the step S107 and continues.

When the received command is a data displaying command (DATA DISPLAYING: step S108), the debugger 422 of the host PC 42 sends a signal corresponding to the command to the debug interface 407 through the debug unit 41. Then, the debug interface 407 reads encrypted data stored in the data memory 403, and outputs the encrypted data to the decrypting unit 427 through the debug unit 41 (step S421). The decrypting unit 427 receives the encrypted data from the debug interface 407 through the debug unit 41. The decrypting unit 427 decrypts the encrypted data using a key code received by the key code input unit 425, to generate decrypted data (step S422). The decrypting unit 427 outputs the decrypted data to the display unit 421. The display unit 421 receives and displays the decrypted data on the display screen (step S423). After this, the procedure of the debug system 4 goes back to the step S107 in FIG. 3 and continues.

When the received command is a data writing command (DATA WRITING: step S108), the instruction/data input unit 428 of the host PC 42 receives an input of data from the user (step S431). The instruction/data input unit 428 sends the received data to the encrypting unit 429. The encrypting unit 429 reads a key code stored in the key code input unit 425, and uses the read key code as an encryption key, to encrypt the data (step S432). The encrypting unit 429 sends the encrypted data to the debug interface 407 through the debug unit 41 (step S433). The debug interface 407 receives the encrypted data, and stores the encrypted data into the data memory 403 (step S434). After this, the procedure of the debug system 4 goes back to the step S107 and continues.

When the received command is an end command (END: step S108), the operation of the host PC 42 ends.

### MODIFICATION EXAMPLE 3

A debug system 5, which is a modification example of the debug system 2, is described.

(Construction)

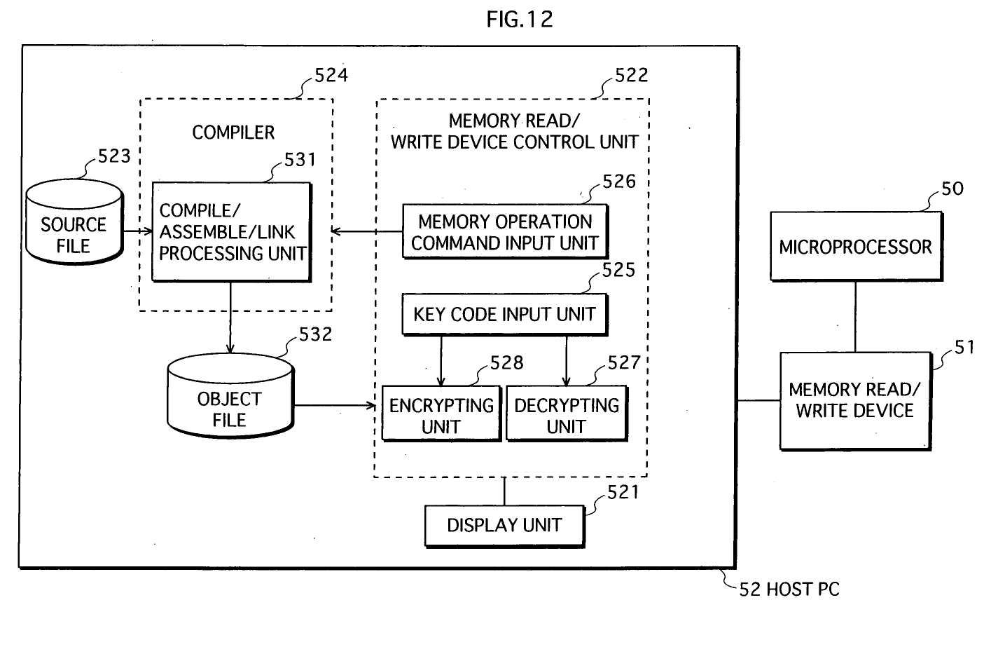

As shown in FIG. 12, the debug system 5 is constituted by a microprocessor 50, a memory read/write device 51, and a host PC 52. The microprocessor 50 is mounted on the substrate of an IC card that is developed by a user of the debug system 5. The memory read/write device 51 reads a program and data in a memory of the microprocessor 50, and writes a program and data into the memory of the microprocessor 50. The memory read/write device 51 is connected to the microprocessor 50 and the host PC 52 by a cable.

The microprocessor 50 is constituted by an instruction memory 501, an instruction executing unit 502, a data memory 503, a data processing unit 504, a nonvolatile memory 505, a decryption circuit 506, and a debug interface 507. As the microprocessor 50 has the same construction as the microprocessor 20 shown in FIG. 5, there is no block diagram illustrating the construction of the microprocessor 50. The constituents of the microprocessor 50 respectively have the same functions as the instruction memory 201, the instruction executing unit 202, the data memory 203, the data processing unit 204, the nonvolatile memory 205, the decryption circuit 206, and the debug interface 207 of the microprocessor 20. Therefore, no explanation on the constituents of the microprocessor 50 is provided here.

The host PC 52 is constituted by a microprocessor, a ROM, a RAM, a hard disk unit, a display screen, a keyboard, a mouse and the like. The hard disk unit stores various kinds of computer programs including a memory read/write device control program.

FIG. 12 is a functional block diagram illustrating functions of the host PC 52. As shown in FIG. 12, the host PC 52 includes a display unit 521 and a memory read/write device control unit 522, a source file 523, and a compiler 524. The memory read/write device control unit 522 includes a key code input unit 525, a memory operation command input unit 526, a decrypting unit 527, and an encrypting unit 528.

The display unit 521 includes a display screen, and displays screen page data output from the memory read/write device control unit 522 on the display screen. When a screen page for receiving an input of a key code is displayed on the display screen, the display unit 521 displays what the key code input unit 525 receives on the display screen. When a screen page for receiving an input of a command is displayed on the display screen, the display unit 521 displays what the memory operation command input unit 526 receives on the display screen.

The key code input unit 525 specifically includes a keyboard, a mouse and the like, and outputs screen page information used to generate a screen page for receiving an input of a key code, to the display unit 521. When a screen page for receiving an input of a key code is displayed on the display unit 521, the key code input unit 525 receives an input of a key code by a user's operation using the keyboard and the mouse. The key code input unit 525 stores the received key code therein. Furthermore, the key code input unit 525 sends the received key code to the debug interface 507 through the memory read/write device 51. The key code input unit 525 discards the key code stored therein if the operation of the memory read/write device control unit 522 is ended.

The memory operation command input unit 526 specifically includes the keyboard, the mouse and the like, and outputs screen page information used to generate a screen page for receiving an input of a command, to the display unit 521. When a screen page for receiving an input of a command is displayed on the display unit 521, the memory operation command input unit 526 receives an input of a command by a user's operation using the keyboard and the mouse. In addition, the memory operation command input unit 526 reads the received command.

When the received command is a reading-from-memory command, the memory operation command input unit 526 sends a signal corresponding to the command to the debug interface 507 through the memory read/write device 51. When the received command is a writing-to-memory command, the memory operation command input unit 526 sends a signal to require the compiler 524 to specify a file to be written, to the compiler 524. When the received command is an end command, the operation of the host PC 52 ends.

The decrypting unit 527 receives an encrypted instruction from the microprocessor 50 through the memory read/write device 51. Then, the decrypting unit 527 reads a key code stored in the key code input unit 525. Using the read key code as a decryption key, the decrypting unit 527 performs the decryption algorithm D₂ to the received encrypted instruction, to generate a decrypted instruction. The decrypting unit 527 outputs the decrypted instruction to the display unit 521.

Here, if a key code received by the key code input unit 525 is the same as a key code stored in the nonvolatile memory 505, the host PC 52 can properly decrypt an encrypted instruction obtained from the microprocessor 50.

The encrypting unit 528 reads the object file 532 from an external storage device. The encrypting unit 528 also reads a key code stored in the key code input unit 525. Using the read key code as an encryption key, the encrypting unit 528 performs the encryption algorithm E₂ to the read object file 532, to generate an encrypted file. The encrypting unit 528 sends the encrypted file to the microprocessor 50 through the memory read/write device 51.

The compiler 524 functionally describes a compiler, an assembler and a linker operating on the host PC 52. The compiler 524 receives a request from the memory operation command input unit 526, and reads a file specified by the request, i.e. the source file 523, from the external storage device. The compiler 524 performs compile, assemble and link operations to the source file 523, to generate the object file 532. Then, the compiler 524 writes the object file 532 into the external storage device.

(Operation)

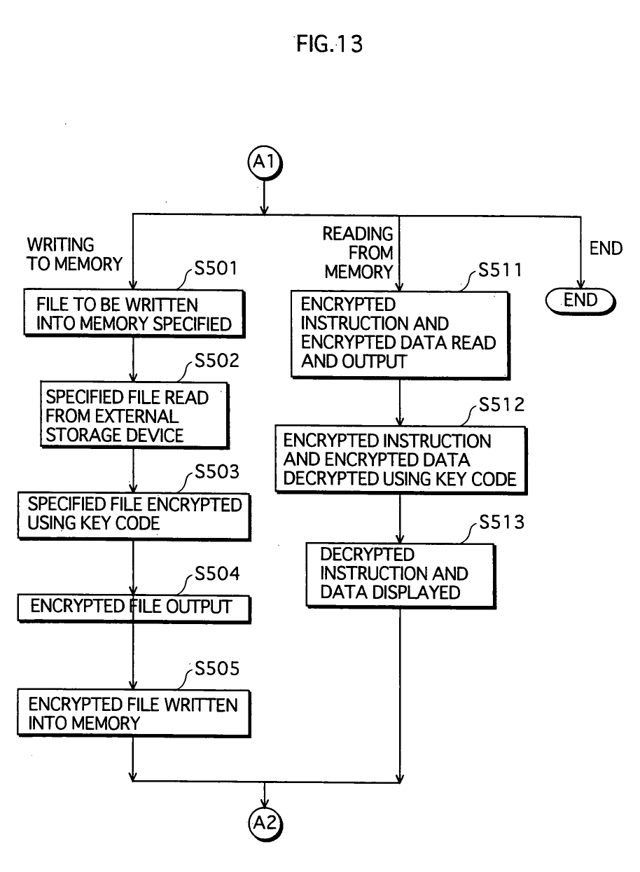

The following part describes the operation of the debug system 5 with reference to the flow charts in FIGS. 3 and 13. The steps S101 to S108 in FIG. 3 are common to the operations of the debug systems 1 and 5. Therefore, no explanation on these steps is provided, and the steps shown in FIG. 13 are explained in the following part.

When the received command is a writing-to-memory command (WRITING TO MEMORY: step S108), the memory operation command input unit 526 of the host PC 52 receives a request which specifies an object file to be written into the microprocessor 50 (step S501). The memory operation command input unit 526 reads the specified object file from the external storage device (step S502), and passes it to the encrypting unit 528. The encrypting unit 528 receives the object file, and performs the encryption algorithm E₂ to the object file using a key code stored in the key code input unit 525 as an encryption key, to encrypt the object file (step S503). The encrypting unit 528 outputs the encrypted object file to the microprocessor 50 through the memory read/write device 51 (step S504), so as to write the encrypted object file to the instruction memory 501 and the data memory 503 of the microprocessor 50 (step S505).

When the received command is a reading-from-memory command, (READING FROM MEMORY: step S108), the memory read/write device control unit 522 of the host PC 52 sends a signal corresponding to the command to the debug interface 507 through the memory read/write device 51. The debug interface 507 reads an encrypted instruction and encrypted data from the instruction memory 501 and the data memory 503 respectively, and outputs them to the decrypting unit 527 through the memory read/write device 51 (step S511). The decrypting unit 527 receives the encrypted instruction and encrypted data, and decrypts them using a key code received by the key code input unit 525, to generate a decrypted instruction and decrypted data (step S512). The decrypting unit 527 outputs the decrypted instruction and decrypted data to the display unit 521, and the display unit 521 receives and displays the decrypted instruction and decrypted data on the display screen (step S513). After this, the procedure of the debug system 5 goes back to the step S107 in FIG. 3 and continues.

When the received command is an end command, the operation of the host PC 52 ends.

### 3. Third Embodiment

A debug system 6 relating to a third embodiment of the present invention is described with reference to the attached figures.

(Construction)

The following part describes the construction of the debug system 6. The debug system 6 is constituted by a microprocessor 60, a debug unit 61, a host PC 62 and an external memory 63. The microprocessor 60 and the external memory 63 are mounted on the substrate of an IC card that is developed by a user of the debug system 6, and are connected to each other by an external bus. The debug unit 61 is connected to the microprocessor 60 and the host PC 62 by a cable. The external memory 63 is divided into (n−1) memory blocks, and each of the memory blocks stores a computer program constituted by an encrypted instruction and data. The computer programs are executed by the microprocessor 60.

According to the debug system 6, multiple developers can debug the operation of the microprocessor 60 using a key code unique to a program which is developed by each of the developers. The following part describes the microprocessor 60 and the host PC 62 in detail.

(Microprocessor 60)

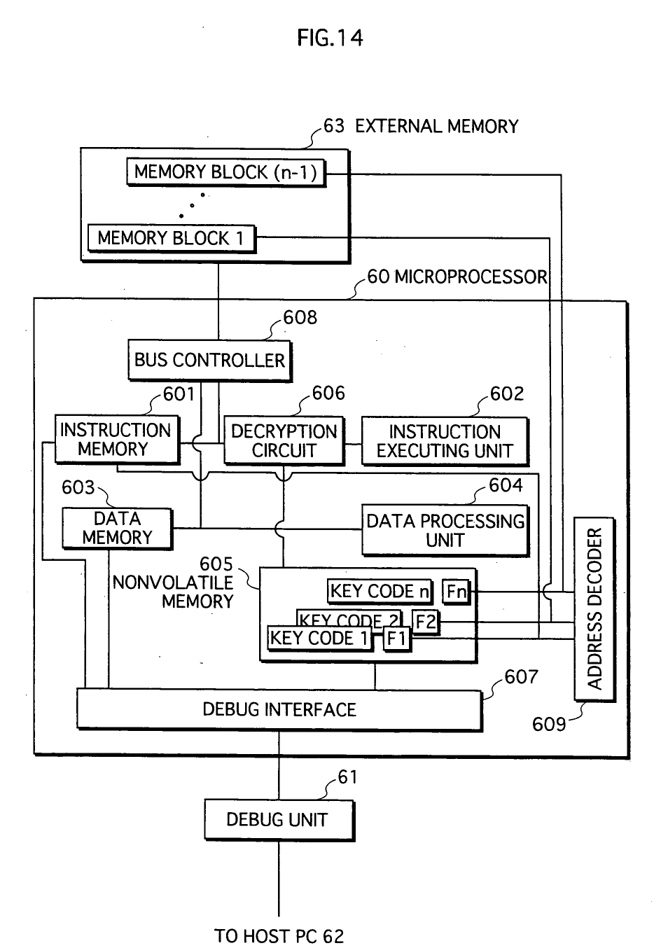

FIG. 14 is a block diagram illustrating a construction of the microprocessor 60. As shown in FIG. 14, the microprocessor 60 is constituted by an instruction memory 601, an instruction executing unit 602, a data memory 603, a data processing unit 604, a nonvolatile memory 605, a decryption circuit 606, a debug interface 607, a bus controller 608, and an address decoder 609.

The instruction memory 601 is specifically composed of a RAM and a ROM, and stores an encrypted instruction. An encrypted instruction stored in the instruction memory 601 is generated by performing an encryption algorithm E₃ to an instruction. The encryption algorithm E₃ is, for example, DES. The instruction memory 601 is connected to the decryption circuit 606 by a bus, and outputs an encrypted instruction to the decryption circuit 606, in response to a request from the instruction executing unit 602. The instruction memory 601 is also connected to the debug interface 607 by a bus. Thus, on reception of a request from a debugger operating on the host PC 62, the instruction memory 601 outputs an encrypted instruction stored therein to the host PC 62 through the debug interface 607 and the debug unit 61. In addition, the instruction memory 601 receives and stores an encrypted instruction output from the debug interface 607.

The instruction executing unit 602 is connected to the decryption circuit 606 by a bus. The instruction executing unit 602 receives, interprets and executes an instruction from the decryption circuit 606.

The data memory 603 is specifically one of a ROM and a RAM, and stores data. The data memory 603 is connected to the data processing unit 604 by a bus. When the data memory 603 receives a request from the data processing unit 604, the data memory 603 outputs data to the data processing unit 604. The data memory 603 receives and stores calculation results output from the data processing unit 604. The data memory 603 is also connected to the debug interface 607 by a bus. Thus, the data memory 603 outputs data stored therein to the host PC 62 through the debug interface 607 and the debug unit 61, on reception of a request from the debugger operating on the host PC 62. Also, the data memory 603 receives and stores data output from the debug interface 607.

The data processing unit 604 is connected to the data memory 603 by a bus. The data processing unit 604 reads data from the data memory 603, performs a calculation on the read data, and writes the result of the calculation to the data memory 603. The data processing unit 604 is connected to the external memory 63 by the external bus and the bus controller 608. Thus, the data processing unit 604 reads data stored in each memory block of the external memory 63 through the bus controller 608, performs a calculation on the read data, and writes the result of the calculation into each memory block.

The nonvolatile memory 605 has an area for storing n key codes from KEY CODE 1 to KEY CODE n, and an area for storing n judgment flags from JUDGMENT FLAG F1 to JUDGMENT FLAG Fn. When a key code is written, it is stored in the corresponding area in the nonvolatile memory 605.

Here, KEY CODE 1 is a decryption key used to decrypt an encrypted instruction stored in the instruction memory 601, and JUDGMENT FLAG F1 is used to judge whether KEY CODE 1 has been written into the nonvolatile memory 605. If KEY CODE 1 is written into the nonvolatile memory 605, JUDGMENT FLAG F1 in the nonvolatile memory 605 is set. Similarly, KEY CODE 2 is a decryption key used to decrypt an encrypted instruction stored in MEMORY BLOCK 1 in the external memory 63, and JUDGMENT FLAG F2 is used whether KEY CODE 2 has been written into the nonvolatile memory 605. Accordingly, KEY CODE n is a decryption key used to decrypt an encrypted instruction stored in MEMORY BLCK (n−1) in the external memory 63, and JUDGMENT FLAG Fn is used to judge whether KEY CODE n has been written into the nonvolatile memory 605.

Once the key codes from KEY CODE 1 to KEY CODE n are written, they are never readable outside of the microprocessor 60 or rewritten. Also, once the judgment flags from JUDGMENT FLAG F1 to JUDGMENT FLAG Fn are set, they can never be rewritten.

The decryption circuit 606 decrypts encrypted instructions stored in the instruction memory 601 and the memory blocks of the external memory 63, so that the instruction executing unit 602 can execute those encrypted instructions. The decryption circuit 606 receives an encrypted instruction from the instruction memory 601 or a memory block of the external memory 63. The decryption circuit 606 retrieves a corresponding key code from the nonvolatile memory 605. Using the retrieved key code as a decryption key, the decryption circuit 606 performs a decryption algorithm D₃ to the encrypted instruction, to generate a decrypted instruction. Here, the decryption algorithm D₃ is an algorithm to decrypt an encrypted text generated using the encryption algorithm E₃. The decryption circuit 606 outputs the decrypted instruction to the instruction executing unit 602.

The debug interface 607 is an interface to connect the instruction memory 601 and the debug unit 61, the data memory 603 and the debug unit 61 and the nonvolatile memory 605 and the debug unit 61, and protects the nonvolatile memory 605. The debug interface 607 has the same functions as the debug interface 207 in the second embodiment. Therefore, detailed explanation on the debug interface 607 is not provided here.

The bus controller 608 performs transfer of information, using the external bus, between the external memory 63 that is disposed outside of the microprocessor 60 and the instruction executing unit 602, and between the external memory 63 and the data processing unit 604.

The address decoder 609 is connected to the instruction memory 601 and the external memory 63 by a bus. The address decoder 609 selects either the instruction memory 601 or one of the memory blocks of the external memory 63 based on an address output from the instruction executing unit 602. Then, the address decoder 609 reads a key code corresponding to the selection from the nonvolatile memory 605, and outputs the read key code to the decryption circuit 606.

(Host PC 62)

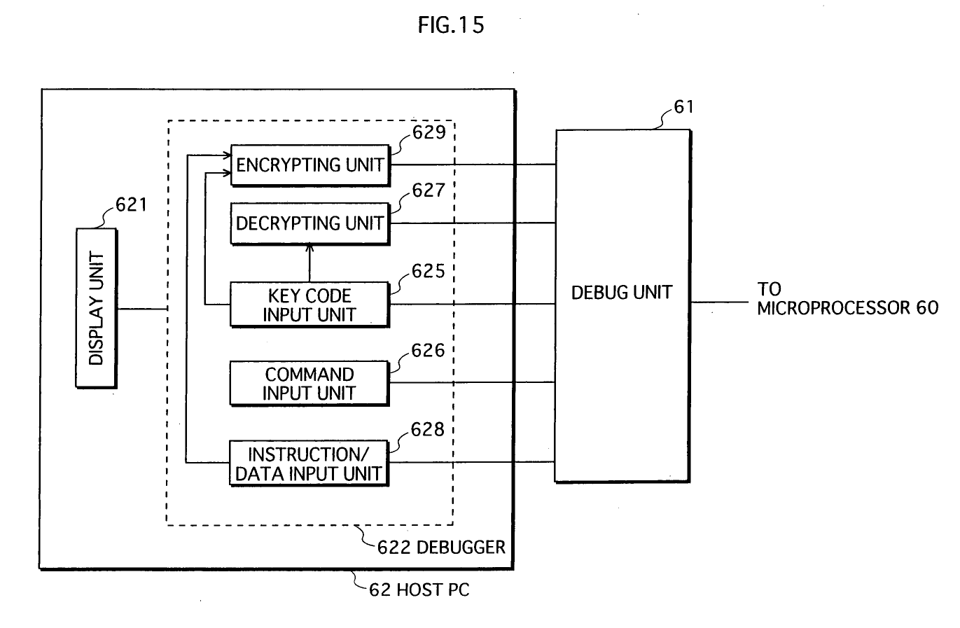

The host PC 62 is a personal computer in which a debugger corresponding to the microprocessor 60 operates, and is owned by a developer who can observe information stored in the instruction memory 601 of the microprocessor 60. As shown in FIG. 15, the host PC 62 includes a display unit 621 and a debugger 622. The debugger 622 includes a key code input unit 625, a command input unit 626, a decrypting unit 627, an instruction/data input unit 628 and an encrypting unit 629. The functions of the display unit 621 and the debugger 622 are the same as those of the display unit 221 and the debugger 222 of the host PC 22. Therefore, detailed explanation on the construction of the host PC 62 is not provided here.

(Operation)

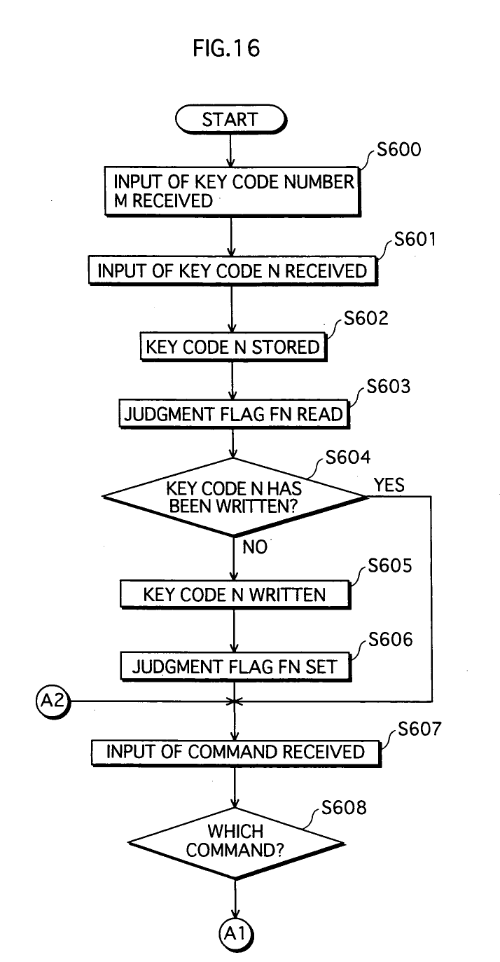

The following part describes the operation of the debug system 6 with reference to a flow chart in FIG. 16.

The debugger 622 of the host PC 62 starts, and the key code input unit 625 receives an input of a key code number M by a user's operation (step S600). Here, M is an integer satisfying 1≦M≦n .

After this, the key code input unit 625 receives an input of KEY CODE N (step S601), and stores KEY CODE N therein (step S602). The key code input unit 625 sends the key code number M and KEY CODE N to the debug interface 607 through the debug unit 61. On reception of the key code number M and KEY CODE N, the debug interface 607 reads JUDGMENT FLAG FN, which is stored in an area in the nonvolatile memory 605 corresponding to the key code number M, so as to judge whether KEY CODE N has been written into an area in the nonvolatile memory 605 to which KEY CODE N should be written (step S603). If KEY CODE N has not been written into that area (NO: step S604), the debug interface 607 writes KEY CODE N into the nonvolatile memory 605 (step S605). Then, the debug interface 607 sets JUDGMENT FLAG FN in the nonvolatile memory 605 so as to indicate KEY CODE N has been written into the nonvolatile memory 605 (step S606).

After this, the command input unit 626 receives an input of a command from the user (step S607). Here, the user selects and inputs one of an instruction displaying command, an instruction writing command, a data displaying command, a data writing command, and an end command. The command input unit 626 reads the received command (step S608). This is followed by the steps in the flow chart shown in FIG. 7.

### 4. Fourth Embodiment

A debug system 7 relating to a fourth embodiment of the present invention is described with reference to the attached figures.

(Construction)

The following part describes the construction of the debug system 7, which is constituted by a microprocessor 70, a debug unit 71, and a host PC 72. The microprocessor 70 is mounted on the substrate of an IC card that is developed by a user of the debug system 7. The debug unit 71 is connected to the microprocessor 70 and the host PC 72 by a cable. The following part describes the microprocessor 70 and the host PC 72 in detail.

(Microprocessor 70)

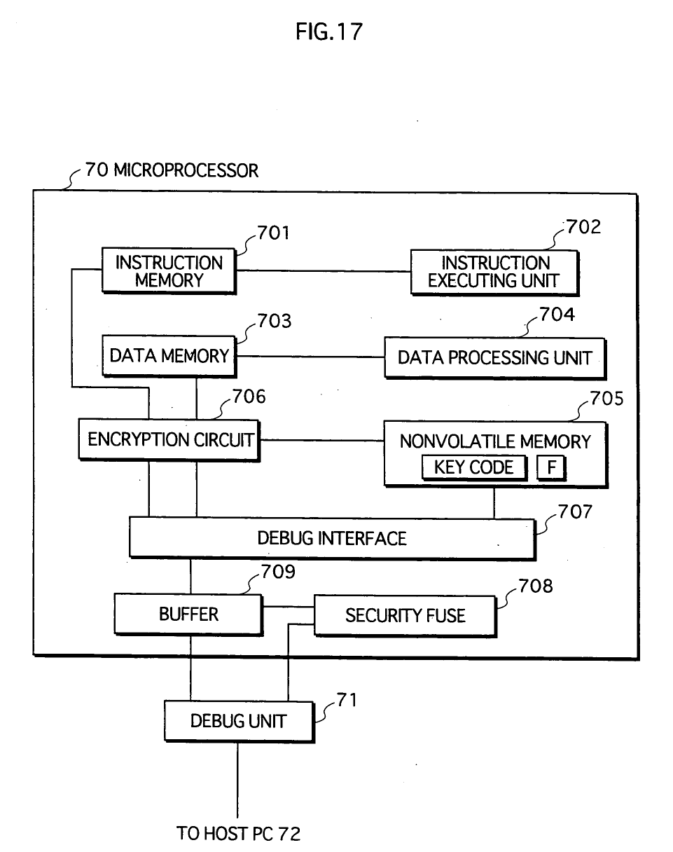

FIG. 17 is a block diagram illustrating a construction of the microprocessor 70. As shown in FIG. 17, the microprocessor 70 is constituted by an instruction memory 701, an instruction executing unit 702, a data memory 703, a data processing unit 704, a nonvolatile memory 705, an encryption circuit 706, a debug interface 707, a security fuse 708 and a buffer 709.

The instruction memory 701 is specifically composed of a RAM and a ROM, and stores an instruction. The instruction memory 701 is connected to the instruction executing unit 702 by a bus. The instruction memory 701 is also connected to the encryption circuit 706 by a bus. Thus, on reception of a request from a debugger operating on the host PC 72, the instruction memory 701 outputs an instruction stored therein to the encryption circuit 706. In addition, the instruction memory 701 receives and stores an instruction output from the encryption circuit 706.

The instruction executing unit 702 is connected to the instruction memory 701 by a bus. The instruction executing unit 702 reads, interprets and executes an instruction stored in the instruction memory 701.

The data memory 703 is specifically one of a ROM and a RAM, and stores data. The data memory 703 is connected to the data processing unit 704 by a bus. When the data memory 703 receives a request from the data processing unit 704, the data memory 703 outputs data to the data processing unit 704. The data memory 703 receives and stores calculation results output from the data processing unit 704. The data memory 703 is also connected to the encryption circuit 706 by a bus. Thus, the data memory 703 outputs data stored therein to the encryption circuit 706, on reception of a request from the debugger operating on the host PC 72. Also, the data memory 703 receives and stores data output from the encryption circuit 706.

The data processing unit 704 is connected to the data memory 703 by a bus. The data processing unit 704 reads data from the data memory 703, performs a calculation on the read data, and writes the result of the calculation to the data memory 703.

The nonvolatile memory 705 has an area for storing a key code and an area for storing a judgment flag. When a key code is written, it is stored in the corresponding area in the nonvolatile memory 705. Here, a key code is an encryption key used by the encryption circuit 706 to encrypt an instruction and data. Once a key code is written, it is never readable outside of the microprocessor 70 or rewritten. A judgment flag is used to judge whether a key code has been written into the nonvolatile memory 705. If a key code is written into the nonvolatile memory 705, a judgment flag in the nonvolatile memory 705 is set. Here, once a judgment flag is set, it can never be reset.

The encryption circuit 706 encrypts an instruction or data, which is read from the instruction memory 701 or the data memory 703 by the debug interface 707 in response to a request from the host PC 72. Here, using a key code stored in the nonvolatile memory 705 as an encryption key, the encryption circuit 706 performs an encryption algorithm E₄ to an instruction stored in the instruction memory 701 or data stored in the data memory 703, to generate an encrypted instruction or encrypted data. The encryption algorithm E₄ is, for example, DES. The encryption circuit 706 outputs an encrypted instruction or encrypted data to the debug interface 707.

The debug interface 707 connects the encryption circuit 706 and the buffer 709, and the nonvolatile memory 705 and the buffer 709. The debug interface 707 protects the encryption circuit 706 and the nonvolatile memory 705. The debug interface 707 has largely the same functions as the debug interface 107 in the first embodiment. However, the debug interface 707 is different in that it outputs an encrypted instruction and encrypted data received from the encryption circuit 706 to the buffer 709.

The security fuse 708 is a flag whose value is set either to 0 or 1. When the value is set to 0, the security fuse 708 is blown and the output from the buffer 709 is inhibited. When the value is set to 1, the output from the buffer 709 is performed. The value of the security fuse 708 is initially set at 1. The value of the security fuse 708 is changed from 1 to 0 in response to a request from a comparison unit 728 of the host PC 72 (mentioned later) through the debug unit 71. Note that the value of the security fuse 708 can not be reset from 0 to 1 if the value of the security fuse 708 has already been changed from 1 to 0.

The buffer 709 is connected to the debug interface 707 and the security fuse 708 by a bus. The buffer 709 reads the value of the security fuse 708. When the value of the security fuse 708 is set to 0, the buffer 709 breaks its connection with the debug unit 71 after the buffer 709 receives an encrypted instruction and encrypted data from the debug interface 707. When the value of the security fuse 708 is set to 1, the buffer 709 is connected to the debug unit 71 and outputs an encrypted instruction and encrypted data received from the debug interface 707 to the debug unit 71.

(Host PC 72)

The host PC 72 is a personal computer in which a debugger corresponding to the microprocessor 70 operates.

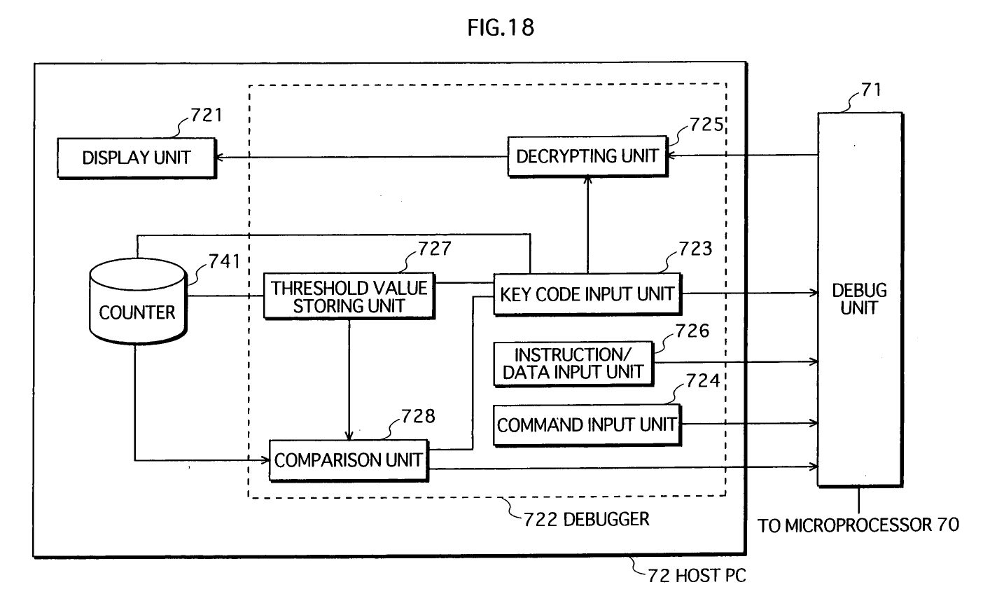

FIG. 18 is a block diagram illustrating a construction of the host PC 72. As shown in FIG. 18, the host PC 72 includes a display unit 721, a debugger 722 and a counter 741. The debugger 722 functionally describes the debugger operating on the host PC 72. The debugger 722 includes a key code input unit 723, a command input unit 724, a decrypting unit 725, an instruction/data input unit 726, and a threshold value storing unit 727, and the comparison unit 728.

The display unit 721 includes a display screen, and displays various kinds of screen pages on the display screen. The functions of the display unit 721 are the same as those of the display unit 121 of the debug system 1. Therefore, detailed explanation on the display unit 721 is not provided here.

The counter 741 is stored in an external storage device. The counter 741 counts the times at which the key code input unit 723 receives a key code which is different from a key code received last time. In accordance with a request from the key code input unit 723, the counter 741 adds one to a numerical value stored therein.

The key code input unit 723 includes, for example, a keyboard and a mouse. The key code input unit 723 has a storage area for storing a key code that is received by the key code input unit 723 last time (hereinafter referred to as a last-time key code). When a screen page for receiving an input of a key code is displayed on the display unit 721, the key code input unit 723 receives an input of a key code by a user's operation using the keyboard and the mouse. On reception of the key code, the key code input unit 723 judges whether the received key code is the same as a last-time key code. If not, the key code input unit 723 outputs, to the counter 741, a signal instructing addition of one to a numerical value stored in the counter 741, and then overwrites the last-time key code stored in the storage area in the key code input unit 723 with the currently received key code.

The key code input unit 723 sends the currently received key code to the nonvolatile memory 705 through the debug unit 71, the buffer 709, and the debug interface 707.

The command input unit 724 has the same functions as the command input unit 124 in the first embodiment. Therefore, no explanation on the command input unit 724 is provided here.

The decrypting unit 725 receives an encrypted instruction from the debug interface 707 through the debug unit 71 and the buffer 709. The decrypting unit 725 reads a key code stored in the key code input unit 723. Using the read key code as an decryption key, the decrypting unit 725 performs a decryption algorithm D₄ to the received encrypted instruction, to generate a decrypted instruction. The decryption algorithm D₄ is an algorithm to decrypt an encrypted text generated using the encryption algorithm E₄. The decrypting unit 725 outputs the decrypted instruction to the display unit 721. Similarly, the decrypting unit 725 receives encrypted data. Using a key code stored in the key code input unit 723 as an decryption key, the decrypting unit 725 performs the decryption algorithm D₄ to the received encrypted data, to generate decrypted data. The decrypting unit 725 outputs the decrypted data to the display unit 721.

The instruction/data input unit 726 has the same functions as the instruction/data input unit 126 in the first embodiment. Therefore, no explanation on the instruction/data input unit 726 is provided here.

The threshold value storing unit 727 stores a threshold numerical value. If the number of times the key code input unit 723 receives a key code which is different from a last-time key code becomes larger than the threshold numerical value, a debug operation is discontinued.

The comparison unit 728 reads and compares the numerical value stored in the counter 741 and the threshold numerical value stored in the threshold value storing unit 727. If the numerical value stored in the counter 741 is larger than the threshold numerical value in the threshold value storing unit 727, the comparison unit 728 sends a signal to change the value from 1 to 0, to the security fuse 708 through the debug unit 71.

(Operation)

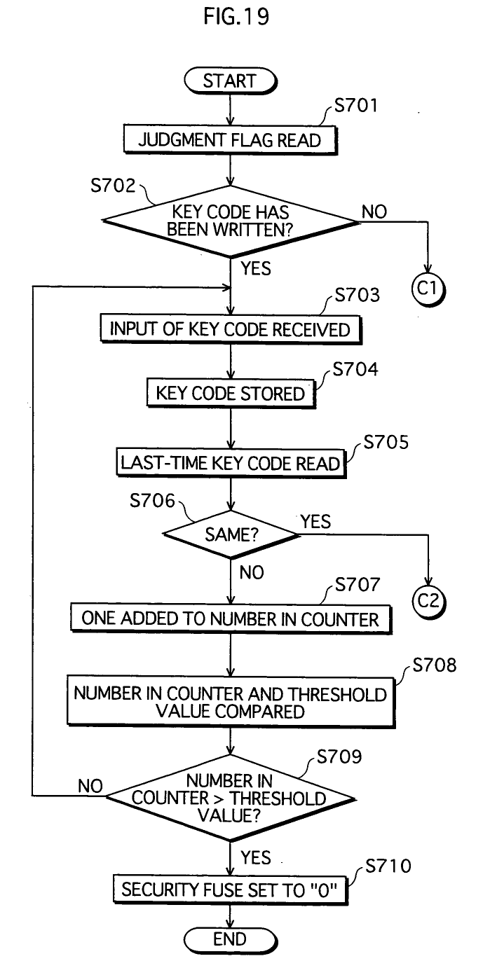

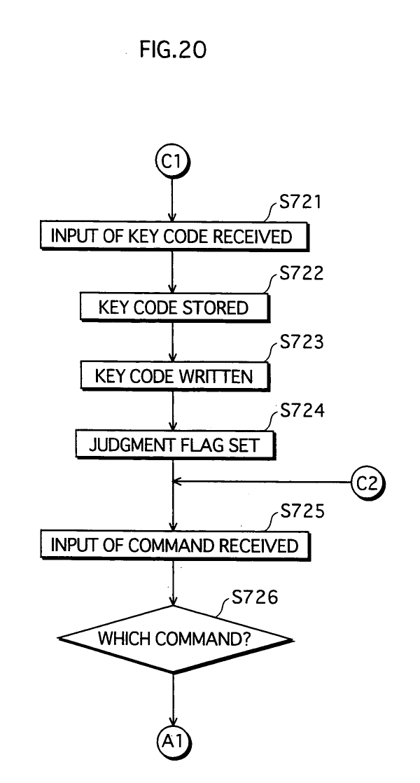

The following part describes the operation of the debug system 7 with reference to the flow charts in FIGS. 19 and 20.

The key code input unit 723 of the host PC 72 reads a judgment flag (step S701), so as to judge whether a key code has been written into the nonvolatile memory 705. If a key code has been written into the nonvolatile memory 705 (YES: step S702), the key code input unit 723 receives an input of a key code from a user (step S703). The key code input unit 723 stores the received key code therein (step S704).

The key code input unit 723 reads a last-time key code stored therein (step S705), and then judges whether the received key code is the same as the last-time key code. If not (NO: step S706), the counter 741 receives a signal from the key code input unit 723, and adds one to a numerical value stored therein (step S707). After this, the comparison unit 728 reads and compares the numerical value stored in the counter 741 and a threshold numerical value stored in the threshold value storing unit 727 (step S708). If the numerical value stored in the counter 741 is larger than the threshold numerical value (YES: step S709), the comparison unit 728 outputs a request to change the value of the security fuse 708 to 0, and blows the security fuse 708 (step S710). If the numerical value stored in the counter 741 is smaller than the threshold numerical value (NO: step S709), the procedure of the debug system 7 goes back to the step S703 and continues.

If the key code input unit 723 finds that a key code has not been written into the nonvolatile memory 705 judging from a judgment flag (NO: step 702), the key code input unit 723 receives an input of a key code from the user (step S721). The key code input unit 723 stores the received key code therein (step S722), and also writes the received key code into the nonvolatile memory 705 through the debug unit 71, the buffer 709 and the debug interface 707 (step S723). After this, the key code input unit 723 sets a judgment flag in the nonvolatile memory 705, through the debug unit 71, the buffer 709 and the debug interface 707, so as to mean that a key code has been written into the nonvolatile memory 705 (step S724).

Subsequently, the command input unit 724 of the host PC 72 receives an input of a command from the user (step S725). Here, the user selects and inputs one of an instruction displaying command, an instruction writing command, a data displaying command, a data writing command, and an end command. The command input unit 724 reads the received command (step S726). These steps are followed by the steps in the flow chart shown in FIG. 4.

If a currently received key code is the same as a last-time key code (YES: step S706), the step S706 is followed by the step S725.

### 5. Fifth Embodiment

A debug system 8 relating to a fifth embodiment of the present invention is described with reference to the attached figures. In the debug system 7, a key code comparing operation is performed in the host PC 72. In the debug system 8, however, that operation is performed in a microprocessor.

(Construction)

The following part describes the construction of the debug system 8, which is constituted by a microprocessor 80, a debug unit 81 and a host PC 82. The microprocessor 80 is mounted on the substrate of an IC card that is developed by a user of the debug system 8. The debug unit 81 is connected to the microprocessor 80 and the host PC 82 by a cable.

The host PC 82 is constituted by a display unit and a debugger. The debugger includes a key code input unit, a command input unit, a decrypting unit, and an instruction/data input unit. The construction of the host PC 82 is not illustrated, as the constituents of the host PC 82 respectively have the same functions as the constituents of the host PC 12 relating to the first embodiment. Accordingly, no explanation on the host PC 82 is provided.

The following part describes the construction of the microprocessor 80.

(Microprocessor 80)

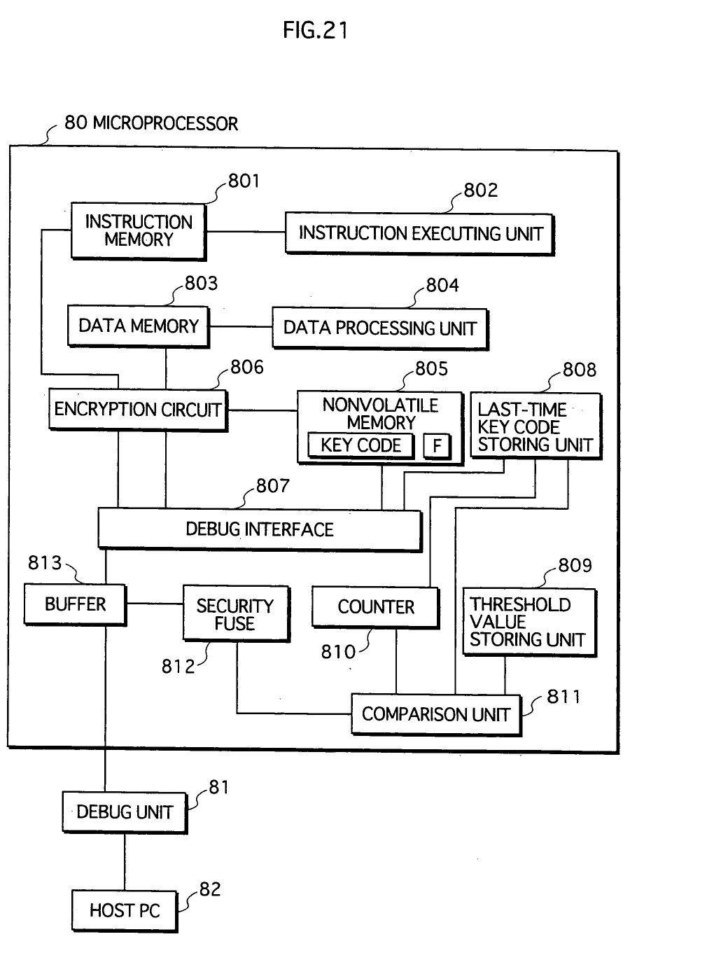

FIG. 21 is a block diagram illustrating a construction of the microprocessor 80. As shown in FIG. 21, the microprocessor 80 is constituted by an instruction memory 801, an instruction executing unit 802, a data memory 803, a data processing unit 804, a nonvolatile memory 805, an encryption circuit 806, a debug interface 807, a last-time key code storing unit 808, a threshold value storing unit 809, a counter 810, a comparison unit 811, a security fuse 812, and a buffer 813.

The instruction memory 801, the instruction executing unit 802, the data memory 803, the data processing unit 804, the nonvolatile memory 805, the encryption circuit 806, and the buffer 813 respectively have the same functions as the instruction memory 701, the instruction executing unit 702, the data memory 703, the data processing unit 704, the nonvolatile memory 705, the encryption circuit 706, and the buffer 709. Therefore, no explanation on these constituents is provided here.

The debug interface 807 connects the encryption circuit 806 and the buffer 813, the nonvolatile memory 805 and the buffer 813, and the last-time key code storing unit 808 and the buffer 813.

The last-time key code storing unit 808 has a storage area for storing a key code that is received from the buffer 813 last time (hereinafter referred to as a last-time key code). The last-time key code storing unit 808 receives a key code that has been received by the key code input unit 823 of the host PC 82 from the debug interface 807 through the debug unit 81 and the buffer 813. Then, the last-time key code storing unit 808 compares the key code received from the debug interface 807 and a last-time key code stored therein. If they are not the same, the last-time key code storing unit 808 outputs, to the counter 810, a signal instructing addition of one to a numerical value stored in the counter 810. In addition, the last-time key code storing unit 808 outputs, to the comparison unit 811, a signal instructing comparison of the numerical value stored in the counter 810 and the threshold numerical value stored in the threshold value storing unit 809.

The threshold value storing unit 809 stores therein a threshold numerical value, which can be written only once. If the number of times the host PC 82 receives a key code, from the user, different from a last-time key code is larger than the threshold numerical value, the security fuse 812 is blown and a debug operation is discontinued.

The counter 810 counts the times at which the host PC 82 receives a key code different from a last-time key code stored in the last-time key code storing unit 808. In accordance with a request from the last-time key code storing unit 808, the counter 810 adds one to the numerical value stored therein.

The comparison unit 811 reads and compares the numerical value stored in the counter 810 and the threshold numerical value stored in the threshold value storing unit 809, in response to a request from the last-time key code storing unit 808. If the numerical value stored in the counter 810 is larger than the threshold numerical value stored in the threshold value storing unit 809, the comparison unit 811 sends, to the security fuse 812, a signal instructing the change of the value to 0.

The security fuse 812 is a flag whose value is set to 0 or 1 like the security fuse 708. When the value is set to 0, the security fuse 812 is blown and the output from the buffer 813 is inhibited. When the value is set to 1, the output of the buffer 813 is performed. The value of the security fuse 812 is initially set to 1, and changed from 1 to 0 in response to a request from the comparison unit 811. Note that the value of the security fuse 812 can not be reset to 1 from 0, if the value has already been changed from 1 to 0.

(Operation)

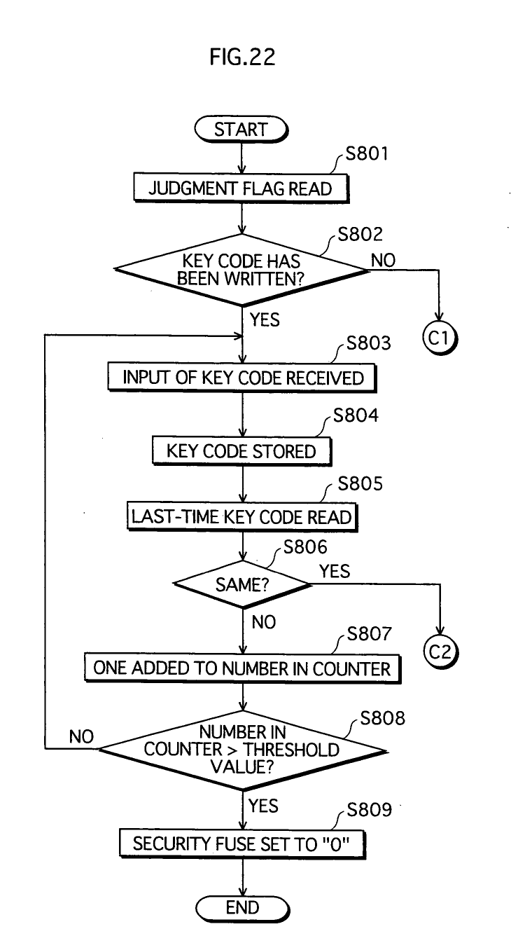

The operation of the debug system 8 is described in the following part with reference to the flow charts shown in FIGS. 20 and 22.

The key code input unit 823 of the host PC 82 reads a judgment flag in the nonvolatile memory 805 (step S801) so as to judge whether a key code has been written into the nonvolatile memory 805. If a key code has been written into the nonvolatile memory 805 (YES: step S802), the key code input unit 823 receives an input of a key code from a user (step S803). The key code input unit 823 stores the received key code therein (step S804).

Subsequently, the key code input unit 823 sends the received key code to the last-time key code storing unit 808 through the debug unit 81, the buffer 813, and the debug interface 807. Then, the last-time key code storing unit 808 reads a last-time key code stored therein (step S805), and judges whether the currently received key code is the same as the last-time key code. If not (NO: step S806), the last-time key code storing unit 808 outputs a signal to the counter 810. On reception of the signal from the last-time key code storing unit 808, the counter 810 adds one to a numerical value stored therein (step S807). After this, the comparison unit 811 reads and compares the numerical value stored in the counter 810 and a threshold numerical value stored in the threshold value storing unit 809. If the numerical value stored in the counter 810 is larger than the threshold numerical value (YES: step S808), the comparison unit 811 outputs a request to change the value of the security fuse 812 from 1 to 0, and then blows the security fuse 812 (step S809). If the numerical value stored in the counter 810 is smaller than the threshold numerical value (NO: step S808), the procedure of the debug system 8 goes back to the step S803 and continues.

If the key code input unit 823 finds that a key code has not been written into the nonvolatile memory 805 judging from a judgment flag (NO: step S802), the procedure of the debug system 8 goes to the step 721 shown in FIG. 20.

If the last-time key code storing unit 808 finds that a currently received key code is the same as a last-time key code stored therein (YES: step S806), the procedure of the debug system 8 goes to the step S725 shown in FIG. 20.

### 6. Sixth Embodiment

A debug system 9 relating to a sixth embodiment of the present invention is described with reference to the attached figures.

(Construction)

The following part describes the construction of the debug system 9. The debug system 9 is constituted by a microprocessor 90, a debug unit 91, and a host PC 92. The microprocessor 90 is mounted on the substrate of an IC card that is developed by a user of the debug system 9. The debug unit 91 is connected to the microprocessor 90 and the host PC 92 by a cable.

The host PC 92 is constituted by a display unit and a debugger. The debugger is constituted by a key code input unit, a command input unit, a decrypting unit, and an instruction/data input unit. The construction of the host PC 92 is not illustrated, as the constituents of the host PC 92 respectively have the same functions as the constituents of the host PC 12 relating to the first embodiment. Accordingly, no explanation on the host PC 92 is provided here.

The following part describes the construction of the microprocessor 90.

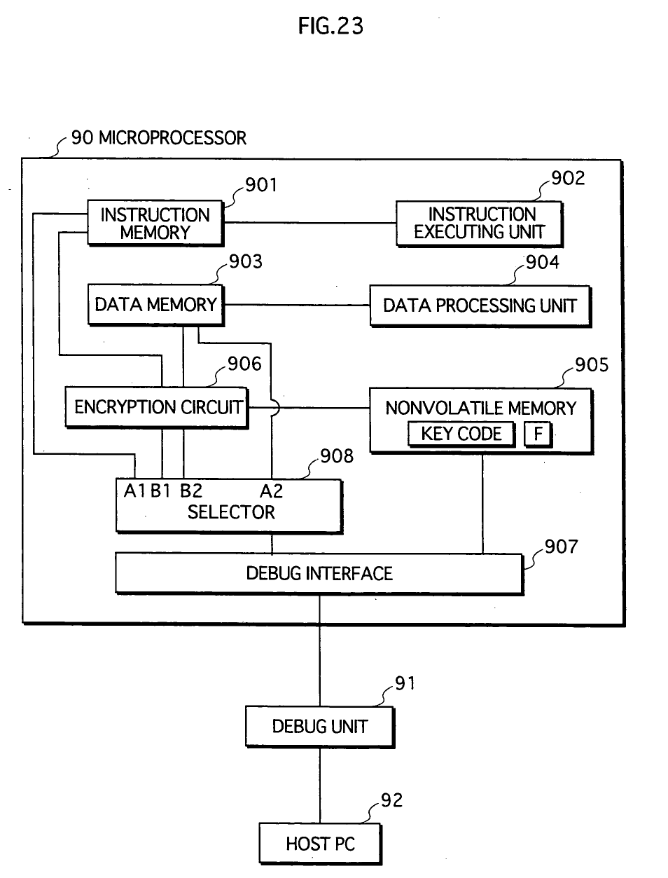

FIG. 23 is a block diagram illustrating the construction of the microprocessor 90. As shown in FIG. 23, the microprocessor 90 is constituted by an instruction memory 901, an instruction executing unit 902, a data memory 903, a data processing unit 904, a nonvolatile memory 905, an encryption circuit 906, a debug interface 907, and a selector 908. The instruction memory 901, the instruction executing unit 902, the data memory 903, the data processing unit 904, the nonvolatile memory 905, the encryption circuit 906, and the debug interface 907 respectively have the same functions as the instruction memory 101, the instruction executing unit 102, the data memory 103, the data processing unit 104, the nonvolatile memory 105, the encryption circuit 106, and the debug interface 107 in the microprocessor 10 relating to the first embodiment. Therefore, explanation on these constituents is not provided here.

The selector 908 is connected to the nonvolatile memory 905 by a bus. Also, the selector 908 is connected to the instruction memory 901 by a bus A1, and to the data memory 903 by a bus A2. The selector 908 is connected to the encryption circuit 906 by an encryption bus B1 and an encryption bus B2. The encryption bus B1 is used for reading and writing an instruction, and connects the encryption circuit 906 and the instruction memory 901. The encryption bus B2 is used for reading and writing data, and connects the encryption circuit 906 and the data memory 903.

The selector 908 reads a judgment flag in the nonvolatile memory 905, and selects one of the buses based on the judgment flag in the following manner.

When a judgment flag in the nonvolatile memory 905 is not set, that is to say, when a key code has not been written into the nonvolatile memory 905, the selector 908 selects the bus A1 for reading and writing an instruction. To perform an instruction reading operation, the selector 908 reads an instruction from the instruction memory 901 through the bus A1, and outputs the read instruction to the debug interface 907. To perform an instruction writing operation, the selector 908 receives an instruction from the debug interface 907, and writes the received instruction to the instruction memory 901 through the bus A1. When a key code has not been written into the nonvolatile memory 905, the selector 908 selects the bus A2 for reading and writing data. To perform a data reading operation, the selector 908 reads data from the data memory 903 through the bus A2, and outputs the read data to the debug interface 907. To perform a data writing operation, the selector 908 receives data from the debug interface 907, and writes the received data into the data memory 903 through the bus A2.

When a judgment flag in the nonvolatile memory 905 is set, that is to say, when a key code has been written into the nonvolatile memory 905, the selector 908 selects the encryption bus B1 to perform an instruction reading operation. The selector 908 reads an instruction from the instruction memory 901 through the encryption bus B1, and outputs the read instruction to the encryption circuit 906. After this, the selector 908 receives an encrypted instruction from the encryption circuit 906 through the encryption bus B1, and outputs the encrypted instruction to the debug interface 907. To perform an instruction writing operation, the selector 908 selects the bus A1. The selector 908 receives an instruction from the debug interface 907, and writes the received instruction to the instruction memory 901 through the bus A1. To perform a data reading operation, the selector 908 selects the encryption bus B2. The selector 908 reads data from the data memory 903 through the encryption bus B2, and outputs the read data to the encryption circuit 906. The selector 908 receives encrypted data from the encryption circuit 906 through the encryption bus B2, and outputs the encrypted data to the debug interface 907. To perform a data writing operation, the selector 908 selects the bus A2. The selector 908 receives data from the debug interface 907, and writes the received data to the data memory 903 through the bus A2.

According to the above construction, when a key code has been written into the nonvolatile memory 905, an encrypted instruction and encrypted data generated by the encryption circuit 906 are output to the host PC 92 through the debug interface 907 and the debug unit 91. On the other hand, when a key code has not been written into the nonvolatile memory 905, an instruction and data, which have not been encrypted, are output to the host PC 92 through the debug interface 907 and the debug unit 91.

(Operation)

The following part describes the operation of the debug system 9 with reference to the flow charts shown in FIGS. 4, 24, and 25.

The debugger of the host PC 92 starts, and the debug interface 907 of the microprocessor 90 reads a judgment flag in the nonvolatile memory 905 (step S901) in response to a signal from the debugger. Thus, the debug interface 907 judges whether a key code has been written into the nonvolatile memory 905.

When a key code has been written into the nonvolatile memory 905 (YES: step S902), the key code input unit of the host PC 92 receives an input of a key code from the user (step S909). The key code input unit outputs the received key code to the debug interface 907 through the debug unit 91. The next step is the step S907. When a key code has not been written (NO: step S902), the debug interface 907 sends a signal indicating that a key code has not been written, to the debugger of the host PC 92 through the debug unit 91.

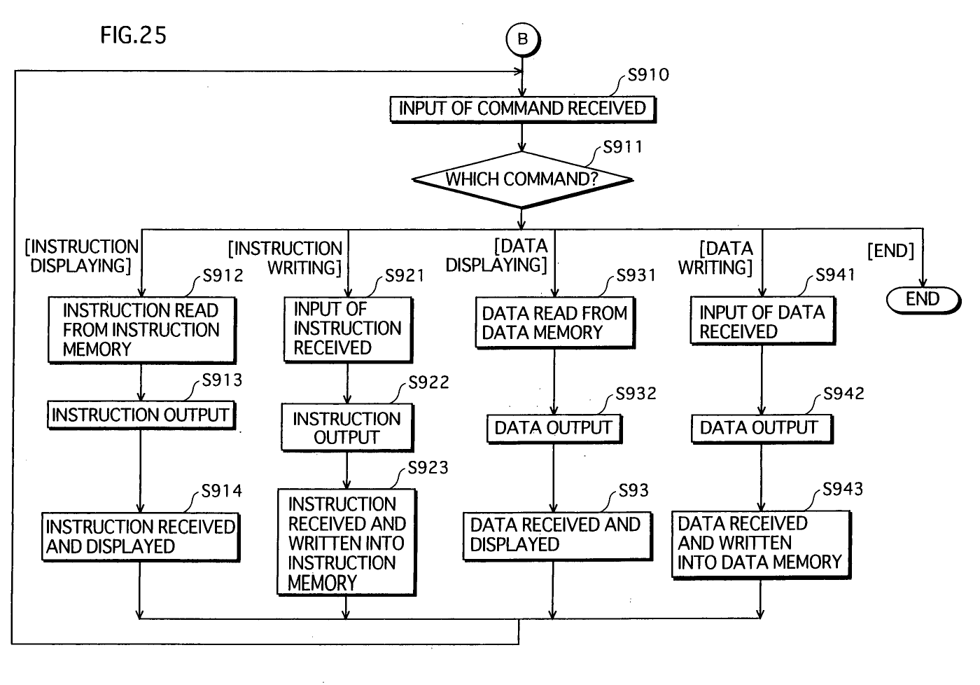

The debugger outputs, to the display unit, a screen page to ask the user if s/he is going to write a key code to the nonvolatile memory 905. While such a screen page is displayed, the key code input unit of the debugger receives an input of a key code from the user. If the user inputs that s/he is not going to write a key code into the nonvolatile memory 905 (NO: step S903), the steps in the flow chart of FIG. 25 are next performed.

Here, the command input unit of the host PC 92 receives an input of a command from the user (step S910). Here, the user selects and inputs one of an instruction displaying command, an instruction writing command, a data displaying command, a data writing command, and an end command. The command input unit reads the received command (step S911).

When the received command is an instruction displaying command (INSTRUCTION DISPLAYING: step S911), the debugger sends a signal corresponding to the command to the debug interface 907 through the debug unit 91. The debug interface 907 reads an instruction from the instruction memory 901 (step S912). The selector 908 selects the bus A1, and outputs the read instruction to the host PC 92 through the debug interface 907 and the debug unit 91 (step S913). The display unit of the host PC 92 receives the instruction, and displays it on the display screen (step S914). After this, the procedure of the debug system 9 goes back to the step S910 and continues.

When the received command is an instruction writing command (INSTRUCTION WRITING: step S911), the instruction/data input unit of the host PC 92 receives an input of an instruction from the user (step S921). The instruction/data input unit sends the received instruction to the debug interface 907 through the debug unit 91 (step S922). The selector 908 selects the bus A1, and the debug interface 907 writes the instruction to the instruction memory 901 through the bus A1 (step S923). After this, the procedure of the debug system 9 goes back to the step S910 and continues.

When the received command is a data displaying command (DATA DISPLAYING: step S911), the debugger of the host PC 92 sends a signal corresponding to the command to the debug interface 907 through the debug unit 91. The debug interface 907 reads data from the data memory 903 (step S931). The selector 908 selects the bus A2, and outputs the data to the host PC 92 through the debug interface 907 and the debug unit 91 (step S932). The display unit of the host PC 92 receives the data and displays it on the display screen (step S933). After this, the procedure of the debug system 9 goes back to the step S910 and continues.

When the received command is a data writing command (DATA WRITING: step S911), the instruction/data input unit of the host PC 92 receives an input of data from the user (step S941). The instruction/data input unit outputs the received data to the debug interface 907 through the debug unit 91 (step S942). The selector 908 selects the bus A2, and the debug interface 907 writes the data into the data memory 903 through the bus A2 (step S943). After this, the procedure of the debug system 9 goes back to the step S910 and continues.

When the received command is an end command (END: step S911), the operation of the host PC 92 ends.

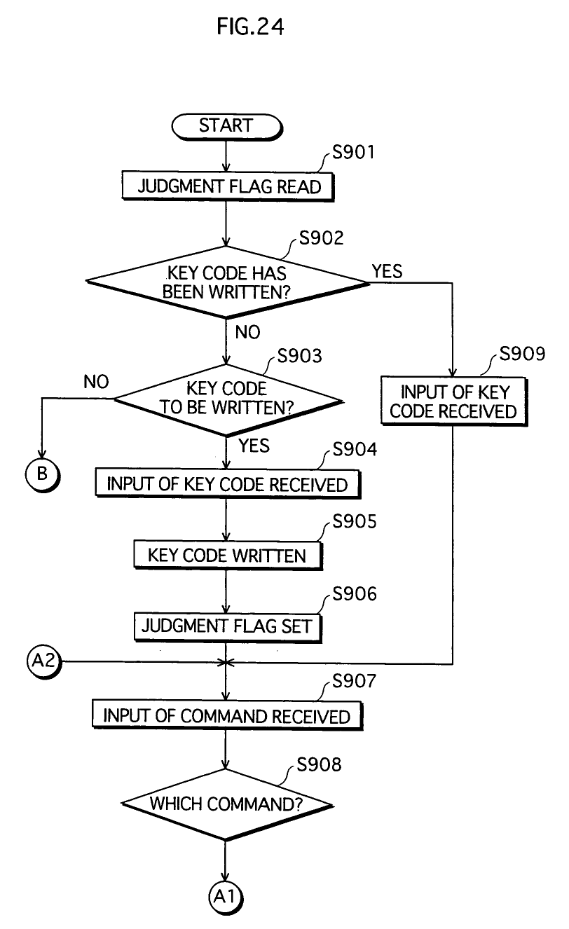

Here, in the step S903 in FIG. 24, if the user inputs that s/he is going to write a key code (YES: step S903), the key code input unit receives an input of a key code from the user (step S904). The key code input unit stores the received key code therein, and also sends the received key code to the debug interface 907 through the debug unit 91. The debug interface 907 receives the key code, and writes the key code into the nonvolatile memory 905 (step 905). In addition, the debug interface 907 sets a judgment flag in the nonvolatile memory 905 so as to indicate that a key code has been written into the nonvolatile memory 905 (step S906).

After this, the command input unit of the host PC 92 receives an input of a command from the user (step S907). Here, the user selects and inputs one of an instruction displaying command, an instruction writing command, a data displaying command, a data writing command and an end command. The command input unit reads the received command (step S908).

Here, the subsequent steps in the operation of the debug system 9 are substantially the same as the steps in the operation of the debug system 1 relating to the first embodiment shown in FIG. 4. Therefore, the following part describes the operation of the debug system 9 with focus on its difference from the debug system 1 with reference to the flow chart of FIG. 4.

When the received command is an instruction displaying command (INSTRUCTION DISPLAYING: step S908), the debug interface 907 reads an instruction from the instruction memory 901 (step S109). The selector 908 selects the encryption bus B1, and outputs the instruction to the encryption circuit 906. The encryption circuit 906 encrypts the instruction to generate an encrypted instruction (step S110). The encryption circuit 906 outputs the encrypted instruction to the debug interface 907 through the encryption bus B1, and the debug interface 907 outputs the encrypted instruction to the host PC 92 through the debug unit 91 (step S111). The following steps for the debug system 9 are the same as the steps S112 and S113 for the debug system 1.

When the received command is an instruction writing command (INSTRUCTION WRITING: step S908), the instruction/data input unit of the host PC 92 receives an input of an instruction from the user (step S121). The instruction/data input unit outputs the received instruction to the debug interface 907 through the debug unit 91 (step S122). The selector 908 selects the bus A1, and the debug interface 907 writes the instruction into the instruction memory 901 through the bus A1 (step S123). After this, the procedure of the debug system 9 goes back to the step S907 and continues.

When the received command is a data displaying command (DATA DISPLAYING: step S908), the debug interface 907 reads data from the data memory 903 (step S131). The selector 908 selects the encryption bus B2 and outputs the read data to the encryption circuit 906. The encryption circuit 906 encrypts the data to generate encrypted data (step S132). The encryption circuit 906 outputs the encrypted data to the debug interface 907 through the encryption bus B2. The debug interface 907 outputs the encrypted data to the host PC 92 through the debug unit 91 (step S133). The following steps for the debug system 9 are the same as the steps S134 and S135 for the debug system 1.

When the received command is a data writing command (DATA WRITING: step S908), the instruction/data input unit of the host PC 92 receives an input of data from the user (step S141). The instruction/data input unit outputs the received data to the debug interface 907 through the debug unit 91 (step S142). The selector 908 selects the bus A2, and the debug interface 907 writes the data to the data memory 903 through the bus A2 (step S143). After this, the procedure of the debug system 9 goes back to the step S907 and continues.

When the received command is an end command (END: step S908), the operation of the host PC 92 ends.

### 7. Seventh Embodiment

A debug system 15 relating to a seventh embodiment of the present invention is described with reference to the attached figures.

The debug system 15 is constituted by a microprocessor 100, a debug unit 110, and a host PC 120. The microprocessor 100 is mounted on the substrate of an IC card that is developed by a user of the debug system 15. The debug unit 110 is connected to the microprocessor 100 and the host PC 120 by a cable. The host PC 120 has the same construction as the host PC 22 relating to the second embodiment, and therefore an explanation on the host PC 120 is not provided here.

(Construction of the Microprocessor 100)

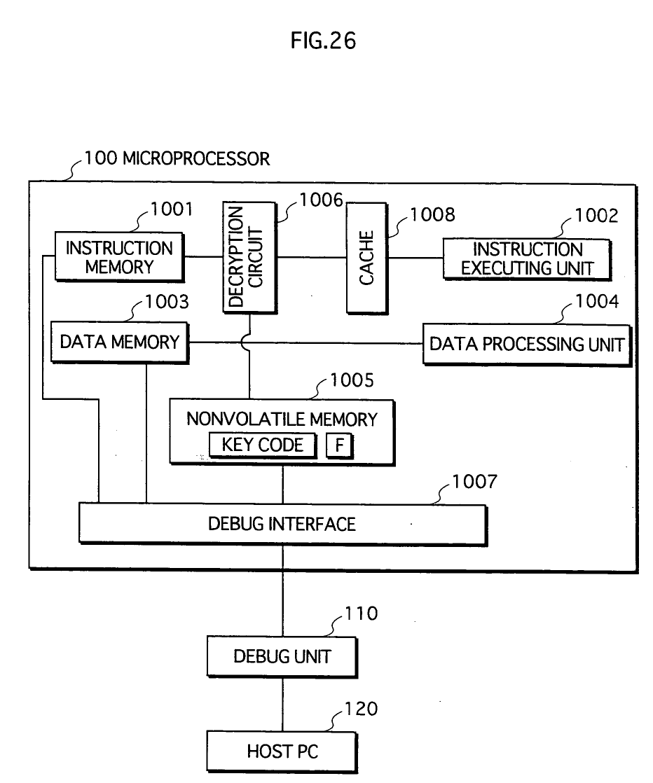

FIG. 26 is a block diagram illustrating a construction of the microprocessor 100. As shown in FIG. 26, the microprocessor 100 is constituted by an instruction memory 1001, an instruction executing unit 1002, a data memory 1003, a data processing unit 1004, a nonvolatile memory 1005, a decryption circuit 1006, a debug interface 1007, and a cache 1008.

The microprocessor 100 is characterized in that the cache 1008 is disposed functionally between the decryption circuit 1006 and the instruction executing unit 1002. The instruction memory 1001, the instruction executing unit 1002, the data memory 1003, the data processing unit 1004, the nonvolatile memory 1005, the decryption circuit 1006, and the debug interface 1007 respectively have the same functions as the corresponding constituents of the microprocessor 20 relating to the second embodiment. The following part describes the microprocessor 100 with focus on its difference from the microprocessor 20.

The cache 1008 is a cache memory disposed functionally between the decryption circuit 1006 and the instruction executing unit 1002. When a time required for execution of an instruction by the instruction executing unit 1003 is longer than a time required for decryption of an encrypted instruction by the decryption circuit 1006, the cache 1008 accumulates therein instructions received from the decryption circuit 1006 while the instruction executing unit 1002 is executing an instruction.

The instruction executing unit 1002 reads an instruction accumulated in the cache 1008, and executes the instruction.

The operation of the debug system 15 is the same as that of the debug system 2. Therefore, no explanation on the operation of the debug system 15 is provided here.

### 8. Other Modifications

According to the debug system and the microprocessor of the present invention as described above, an instruction and data can be encrypted using a key code input by a user on a host PC, on which a debugger operates, so as to be transmitted between the microprocessor and the host PC. In addition, even though a vicious user connects the microprocessor of the present invention to a debug unit so as to analyze the microprocessor, the vicious user only obtains an encrypted instruction and encrypted data from the microprocessor. Such an encrypted instruction and encrypted data can not be decrypted without a correct key code stored in a nonvolatile memory in the microprocessor. Therefore, the vicious user can not analyze the information stored in the microprocessor. Furthermore, even the designers of the microprocessor and the debug system, and the developers of a program do not know a correct key code. It is only the person who sets a correct key code who can analyze the information stored in the microprocessor. As a result, both a debug operation and security can be achieved in, for example, an electronic money system, which requires high-level security.

The present invention is described with reference to the embodiments in the above part. However, the present invention is not limited to those embodiments, and includes the following modifications.

(1) According to the above embodiments, the microprocessor to be debugged is mounted on the substrate of an IC card. However, the present invention is not limited to an IC card. The microprocessor may be mounted on any substrate developed by a user of the debug system.

(2) According to the above embodiments, a command of a debugger is one of an instruction displaying command, an instruction writing command, a data displaying command, a data writing command, and an end command, but not limited thereto.

(3) According to an instruction writing operation relating to the second embodiment, an instruction received by the instruction/data input unit 228 of the debugger 222 is encrypted and then stored into the instruction memory 201 of the microprocessor 20. However, the following procedure is also acceptable. The debugger 222 specifies a source file stored in the external storage device. Then, the compiler 224 reads the specified source file, to generate an object file. Furthermore, the compiler 224 encrypts the generated object file, and stores the encrypted object file into the instruction memory 201 in the microprocessor 20. Alternatively, the compiler 224 may store an encrypted object file into the external storage device beforehand. The debugger 222 reads the encrypted object file from the external storage device, and writes it into the instruction memory 201 of the microprocessor 20.

(4) As for the second embodiment, a key code stored in the nonvolatile memory 205 can not be read out, but may be rewritten. This does not pose any security problems as long as a key code specified by the compiler is not known. More specifically, even though a key code stored in the nonvolatile memory 205 is rewritten, an instruction can not be performed properly.

(5) According to the third modification example of the second embodiment, the object of the memory read/write device 51 is the microprocessor 50, but not limited thereto. For example, a memory disposed outside of the microprocessor 50 can be the object of the memory read/write device 51.

(6) According to the third embodiment, any key code is input by a person who performs a debug operation. Alternatively, a key code unique to a program may be, in advance, secretly set, and the unique key code and a key code number corresponding to the unique key code may be secretly informed to a person who debugs the program.

In addition, the key codes may not correspond to the memory blocks (nonvolatile memory 605 and the memory blocks of the external memory 63) in one-to-one correspondence. As long as a memory is managed by using key codes the number of which corresponds to the number of secret programs in the memory, one key code may correspond to a plurality of memory blocks.

(7) An encryption algorithm for encrypting an instruction and data is not limited to DES, but may be a public key cryptosystem.

(8) The present invention can be the operations described in the above part, a computer program that executes the operations using a computer, or a digital signal composed by the computer program.

The present invention may be the computer program or the digital signal in a state of being stored in a computer readable storage medium, for example, a floppy disk, a hard disk, a CD-ROM, an MO, a DVD-ROM, a DVD-RAM, or a semiconductor memory. Alternatively, the present invention may be transmission of the computer program or the digital signal stored in the above-mentioned recording media via a network, such as an electronic communication network, a wireless or a fixed-line communication network, and the Internet.

The present invention may be a computer system including a microprocessor and a memory. Here, the memory stores the above-mentioned computer program, and the microprocessor operates based on the computer program.

The present invention may be realized in the following manner. The above-mentioned computer program or digital signal in a state of being stored in the above-mentioned storage media is transferred, or the computer program or the digital signal is transmitted via a network or the like, so as that a different computer system executes the computer program or the digital signal.

(9) The present invention also includes combinations of any of the first to the seventh embodiments. The present invention also includes combinations of the above modifications and the embodiments.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A debug system comprising:
a microprocessor operable to store secret program information; and
a host computer that is connected to the microprocessor so as to debug the program information in the microprocessor, wherein
the microprocessor includes:
a nonvolatile memory which (i) has an area for storing key information that is used to securely handle program information and (ii) is writable only once;
a writing unit operable to, if no key information is stored in the nonvolatile memory, receive key information from the host computer and write the key information into the nonvolatile memory; and
a first transmission unit operable to securely perform transmission of program information with the host computer using the key information that has been written into the nonvolatile memory,
the key information that has been written into the nonvolatile memory is not readable outside of the microprocessor, and
the host computer includes:
a receiving unit operable to receive key information from a user;
a sending unit operable to store therein the key information received from the user and send the key information to the microprocessor; and
a second transmission unit operable to securely perform transmission of program information with the microprocessor using the key information stored in the sending unit.

2. A microprocessor which is operable to store secret program information and is connected to a host computer that is used to debug the program information in the microprocessor, comprising:
a program information storing unit operable to store the program information which is one of a program, data and a program and data;
an executing unit operable to read the program information to perform an operation corresponding to the read program information;
a nonvolatile memory which (a) has an area for storing key information that is used to securely handle program information and (b) is writable only once;
a writing unit operable to, if no key information is stored in the nonvolatile memory, receive key information from the host computer and write the received key information into the nonvolatile memory; and
a transmission unit operable to securely perform transmission of program information with the host computer using the key information that has been written into the nonvolatile memory, wherein
the key information that has been written into the nonvolatile memory is not readable outside of the microprocessor.

3. The microprocessor of claim 2, wherein
the nonvolatile memory additionally stores therein flag information that indicates whether key information is stored in the nonvolatile memory,
the transmission unit reads the flag information, and
if the read flag information indicates that no key information is stored in the nonvolatile memory, the writing unit receives the key information from the host computer, and writes the key information received from the host computer into the nonvolatile memory.

4. The microprocessor of claim 3, wherein
the transmission unit includes:
an encryption unit operable to encrypt the program information stored in the program information storing unit using the key information that has been stored in the nonvolatile memory; and
an output unit operable to output the encrypted program information.

5. The microprocessor of claim 4, wherein
the transmission unit further includes
an inhibition unit operable to, in response to a request from the host computer, inhibit the output unit from outputting the encrypted program information.

6. The microprocessor of claim 4, wherein
the transmission unit further includes:
an inhibition condition storing unit storing an inhibition condition that relates to the key information received from the host computer; and
an inhibition unit operable to, if the key information received from the host computer satisfies the inhibition condition, inhibit the output unit from outputting the encrypted program information.

7. The microprocessor of claim 3, wherein
the program information stored in the program information storing unit is encrypted program information which is one of an encrypted program, encrypted data, and an encrypted program and encrypted data,
the executing unit (i) reads the key information that has been stored in the nonvolatile memory, (ii) decrypts the encrypted program information using the read key information so as to generate decrypted program information which is one of a decrypted program, decrypted data, and a decrypted program and decrypted data, and (iii) performs an operation corresponding to the decrypted program information, wherein
the transmission performed by the transmission unit is transmission of encrypted program information.

8. The microprocessor of claim 5, wherein
the executing unit encrypts a result of the operation using the key information that has been stored in the nonvolatile memory, and writes the encrypted result into the program information storing unit.

9. The microprocessor of claim 5, wherein
the program stored in the program information storing unit is an encrypted program, and
the program information storing unit has a path to communicate with an external device.

10. The microprocessor of claim 5, wherein
the key information that has been written into the nonvolatile memory is constituted by one or more pieces of partial key information,
the program stored in the program information storing unit is a plurality of encrypted partial programs each of which corresponds to any of the pieces of partial key information, and
the executing unit (a) reads a piece of partial key information from the nonvolatile memory, (b) reads one or more of the encrypted partial programs corresponding to the read piece of partial key information, from the program information storing unit, (c) decrypts the read encrypted partial programs using the read piece of partial key information to generate decrypted partial programs, and (d) performs an operation corresponding to the decrypted partial programs.

11. The microprocessor of claim 3, further including
a cache memory, wherein
the program information stored in the program information storing unit is encrypted program information which is one of an encrypted program, encrypted data, and an encrypted program and encrypted data,
the executing unit (a) reads the key information that has been stored in the nonvolatile memory, (b) decrypts the encrypted program information using the read key information so as to generate decrypted program information which is one of a decrypted program, decrypted data and a decrypted program and decrypted data, (c) writes the decrypted program information into the cache memory, (d) reads the decrypted program information from the cache memory in accordance with a processing speed of the executing unit, and (e) performs an operation corresponding to the decrypted program information, and
the transmission performed by the transmission unit is transmission of encrypted program information.

12. The microprocessor of claim 2, wherein
the nonvolatile memory additionally stores flag information indicating whether the key information is stored in the nonvolatile memory,
the transmission unit reads the flag information,
if the read flag information indicates that no key information is stored in the nonvolatile memory, the transmission unit reads the program information from the program information storing unit and outputs the read program information to the host computer, and
if the read flag information indicates that the key information has been stored the nonvolatile memory, the transmission unit reads the program information from the program information storing unit, encrypts the read program information using the key information that has been stored in the nonvolatile memory, and outputs the encrypted program information to the host computer.

13. A host computer which (i) is connected to a microprocessor operable to store secret program information and (ii) debugs the program information in the microprocessor, comprising:
a receiving unit operable to receive key information from a user;
a sending unit operable to store the received key information therein and send the received key information to the microprocessor; and
a transmission unit operable to securely perform transmission of program information with the microprocessor using the key information stored in the sending unit.

14. The host computer of claim 13, wherein
the transmission unit includes:
a program information receiving unit operable to receive, from the microprocessor, encrypted program information which has been generated by encrypting the program information;
a decrypting unit operable to decrypt the encrypted program information using the key information stored in the sending unit so as to generate decrypted program information; and
a display unit operable to display the decrypted program information generated by the decrypting unit.

15. The host computer of claim 14, wherein
the transmission unit further includes:
a program information input unit operable to receive, from the user, program information which is one of a program, data and a program and data;
an encrypting unit operable to encrypt the program information received from the user, using the key information stored in the sending unit so as to generate encrypted program information; and
an output unit operable to output the encrypted program information generated by the encrypting unit to the microprocessor.

16. The host computer of claim 14, further comprising:
a storage unit storing a source program;
a conversion unit operable to convert the source program into an object program; and
an encrypting unit operable to encrypt the object program using the key information stored in the sending unit so as to generate an encrypted program, wherein
the transmission unit transmits the encrypted program generated by the encrypting unit to the microprocessor.

17. The host computer of claim 14, wherein
the transmission unit further includes:
an inhibition condition storing unit storing an inhibition condition that relates to the key information; and
an inhibition request output unit operable to, if the key information satisfies the inhibition condition, output a request, to the microprocessor, to inhibit the transmission of the encrypted program information.

18. A read/write device that is connected to a microprocessor operable to store secret program information, comprising:
a receiving unit operable to receive key information from a user;
a sending unit operable to store the received key information therein and send the received key information to the microprocessor; and
a transmission unit operable to securely perform transmission of program information with the microprocessor using the key information.
